(19) United States
(12) Patent Application Publication
(10) Pub. No.: US 2025/0096223 A1
(43) Pub. Date: Mar. 20, 2025

(54) SECONDARY BATTERY AND METHOD FOR PREPARING SAME

(71) Applicants: JINKO SOLAR CO., LTD., Jiangxi (CN); ZHEJIANG JINKO ENERGY STORAGE CO., LTD., Haining City (CN)

(72) Inventors: Longhui LIAO, Jiangxi (CN); Zixiang YANG, Jiangxi (CN); Shuqing CHEN, Jiangxi (CN)

(21) Appl. No.: 18/964,238

(22) Filed: Nov. 29, 2024

(30) Foreign Application Priority Data
Oct. 23, 2024 (CN) 202411488398.8
Oct. 23, 2024 (CN) 202411491464.7

(51) Int. Cl. H01M 4/04; H01M 4/62; H01M 10/0525; H01M 10/058

(52) U.S. Cl. CPC H01M 4/0416; H01M 4/622; H01M 4/625; H01M 10/0525; H01M 10/058

(57) ABSTRACT

Provided is a method for preparing a secondary battery including a battery cell. The secondary battery includes a negative electrode. The method includes: preparing a negative electrode slurry, coating the negative electrode slurry on the negative current collector, and then drying and compacting the negative electrode slurry to form a negative electrode material coating, thereby obtaining the negative electrode. Preparing the negative electrode slurry includes: dry blending a negative electrode active material, a conductive agent and a dispersant to obtain a dry blend; kneading the dry blend with a part of the first solvent to obtain a kneaded material; subjecting the kneaded material, the remaining part of the first solvent, the second solvent to a first wet blending to obtain a first wet blend; and subjecting the first wet blend, a thickener and a binder to a second wet blending to obtain the negative electrode slurry.

### CROSS REFERENCE TO RELATED APPLICATIONS

The present application claims the benefit of priority under the Paris Convention to Chinese Patent Application No. CN 202411491464.7 filed on Oct. 23, 2024, and Chinese Patent Application No. CN 202411488398.8 filed on Oct. 23, 2024, each of which is incorporated by reference herein in its entirety.

### TECHNICAL FIELD

Embodiments of the present disclosure relate to the field of secondary batteries, and in particular, to a secondary battery and a method for preparing the same.

### BACKGROUND

Electrode sheet manufacturing is critical to the performance of lithium-ion batteries, where the coating process is a core operation in ensuring the quality of electrode sheets, and has a direct impact on the success or failure of subsequent processes such as roll pressing and die cutting. Coating is a process of uniformly applying a homogenously blended slurry to a collector and then drying the slurry. The final quality of the coating is determined by a combination of factors such as slurry properties, drying conditions and a coating rate. In the coating process, there may exist a variety of defects, including too large thickness of an edge (i.e., “thick edge”) which is a common problem (see FIG. 1), and occurs at the edge of a negative electrode sheet due to the fact that when the graphite aqueous slurry is coated and dried, water evaporates faster due to its larger surface area to volume ratio, so that the slurry particles move towards the edge under capillary force to form a “thick edge”, which significantly increases the thickness of the edge portion of the electrode sheet after drying. In this case, a thickness of the coating at the edge is a few microns to a dozen microns greater than a thickness of the coating in the normal area, which leads to the accumulative formation of a larger bump in the coating and winding process of the electrode sheet, causing the edge of the electrode sheet to bulge, which in extreme cases may lead to fracture of the electrode sheet. In addition, the phenomenon of thick edge also leads to higher pressure on the edge of the electrode sheet in roll pressing, resulting in uneven lateral density of the electrode sheet, and further affecting the overall performance and safety of the battery.

Accordingly, a more ideal method is desired to eliminate the problem of “thick edge” of the coating.

### SUMMARY

The present disclosure provides a secondary battery and a method for preparing the same, in order to solve the problem of difficulty in balancing the electrical performance and the safety performance of the battery cell in the existing art when solving the problem of “thick edge” of the coating occurring in the coating process of the electrode sheet.

To achieve the above objective, according to one aspect of the present disclosure, a method for preparing a secondary battery is provided. The secondary battery includes a battery cell, the battery cell includes a positive electrode, a negative electrode, a separator and an electrolyte, and the negative electrode includes a negative current collector, and a negative electrode material coating laminated to a surface of the negative current collector. The method includes: preparing a negative electrode slurry, coating the negative electrode slurry on the negative current collector, and then drying and compacting the negative electrode slurry to form the negative electrode material coating, thereby obtaining the negative electrode; preparing a positive electrode slurry, coating the positive electrode slurry on a positive electrode collector, and then drying and compacting the positive electrode slurry, thereby obtaining the positive electrode; and assembling the positive electrode, the negative electrode, the separator and the electrolyte to obtain the secondary battery. Preparing the negative electrode slurry includes: blending a negative electrode active material, a conductive agent, a binder, a dispersant, a solvent, and a thickener to obtain the negative electrode slurry. An amount of the negative electrode active material is 96 to 98 parts by weight, an amount of the conductive agent is 0.6 to 1.2 parts by weight, an amount of the binder is 1 to 2.5 parts by weight, an amount of the dispersant is 0.5 to 1.5 parts by weight, an amount of a solvent is 80 to 100 parts by weight, and an amount of the thickener is 1.5 to 3 parts by weight. The solvent includes the first solvent and the second solvent, the first solvent is water, the second solvent is an organic solvent, the second solvent has a boiling point of 110° C. to 210° C. and a surface tension of 20 dyn/cm to 50 dyn/cm, and a mass ratio of the second solvent to the first solvent is 1:10 to 1:2.

In some embodiments, blending the negative electrode active material, the conductive agent, the binder, the dispersant, the solvent, and the thickener to obtain the negative electrode slurry includes: dry blending the negative electrode active material, the conductive agent and the dispersant to obtain a dry blend; kneading the dry blend with a part of the first solvent to obtain a kneaded material; subjecting the kneaded material, the remaining part of the first solvent, the second solvent to a first wet blending to obtain a first wet blend; and subjecting the first wet blend, the thickener and the binder to a second wet blending to obtain the negative electrode slurry.

In some embodiments, the boiling point of the second solvent is 10° C. to 110° C. higher than a boiling point of the water, the surface tension of the second solvent is 15 dyn/cm to 50 dyn/cm lower than a surface tension of the water, and the water is deionized water.

In some embodiments, an amount of the second solvent is 15 to 30 parts by weight.

In some embodiments, the second solvent is selected from any one or more of ethylene glycol, ethylenediamine, butanol, acetic acid, propylene glycol and methyl formamide.

In some embodiments, the negative electrode slurry has a viscosity of 6000 Pa·s to 9000 Pa·s.

In some embodiments, the negative electrode active material is selected from any one or more of graphite, a silicon material, a silicon carbon material, and hard carbon.

In some embodiments, the conductive agent is selected from any one or more of a SP (Super-P) conductive agent, carbon black, carbon nanotubes, graphene.

In some embodiments, the binder is at least one of an SBR (styrene butadiene rubber) binder and a PAA (polyacrylic acid) binder.

In some embodiments, the dispersant is a CMC (carboxymethyl cellulose) dispersant

In some embodiments, in a width direction of the negative electrode material coating, the negative electrode material coating includes an intermediate zone and an edge transition zone disposed on each of both sides of the intermediate zone, a thickness of the edge transition zone gradually decreases in a direction away from the intermediate zone, the intermediate zone has a thickness of H1, and the edge transition zone has a width of L2 in the direction away from the intermediate zone, wherein L2/H1 is 0.004 to 0.01:1.

In some embodiments, L2 is 1 mm to 2 mm, and H1 is 200 mm to 230 mm.

In some embodiments, a mass ratio of the thickener to the second solvent is 1:20 to 1:5.

In some embodiments, the thickener is selected from any one or more of polyethylene glycol, polyacrylate, and hydroxyethyl cellulose.

In some embodiments, the polyethylene glycol has a molecular weight of less than 600.

In some embodiments, the negative electrode slurry includes 96 to 97 parts by weight of graphite, 0.8 to 1.0 parts by weight of a SP conductive agent, 2 to 2.5 parts by weight of a SBR binder, 1.2 to 1.5 parts by weight of a CMC dispersant, 15 to 30 parts by weight of ethylene glycol, 60 to 75 parts by weight of deionized water, and 2 to 3 parts by weight of polyethylene glycol.

In some embodiments, parameters during the dry blending include: a rotational speed of 15 rpm to 25 rpm, a stirring speed of 500 rpm to 800 rpm, and a stirring time of 30 min to 60 min.

In some embodiments, parameters during the kneading include: a kneading time of 60 min to 80 min, a rotational speed of 20 rpm to 25 rpm, and a stirring speed of 300 rpm to 500 rpm.

In some embodiments, parameters during the first wet blending include: a rotational speed of 22 rpm to 25 rpm, a stirring speed of 1000 rpm to 1500 rpm, and a stirring time of 90 min to 120 min.

In some embodiments, parameters during the second wet blending include: a rotational speed of 22 rpm to 25 rpm, a stirring speed of 300 rpm to 600 rpm, and a stirring time of 30 min to 40 min.

### BRIEF DESCRIPTION OF THE DRAWINGS

The accompanying drawings, which form part of the present disclosure, are used to provide a further understanding of the present disclosure, and exemplary embodiments of the present disclosure and their descriptions are used to explain the present disclosure and do not constitute an improper limitation to the present disclosure. In the accompanying drawings:

FIG. 1 is a schematic diagram illustrating a coating with an excessively thick edge formed during a coating process of an electrode sheet in the prior art;

FIG. 2 is a schematic diagram illustrating the drying principle of the negative electrode coating shown in FIG. 1;

FIG. 3 is a schematic diagram illustrating a coating edge obtained by thinning the edge of the electrode sheet during coating in the prior art;

FIG. 4 is a schematic diagram illustrating a coating edge formed during coating of the electrode sheet according to embodiment one of the present disclosure;

FIG. 5 is a schematic diagram illustrating the drying principle of the negative electrode coating shown in FIG. 4;

FIG. 6 is a flow chart of a process for preparing a negative electrode slurry according to embodiment 1 of the present disclosure;

FIG. 7 is a distribution diagram of thickness measurement results from #1 to #5 in the present disclosure;

FIG. 8 is a distribution diagram of thickness measurement results of the coating of the negative electrode sheet in embodiments 1 to 7 and comparative examples 1 to 5 in the present disclosure.

FIG. 9 is a flow chart of a process for preparing a negative electrode slurry according to embodiment 8 of the present disclosure;

FIG. 10 is a distribution diagram of thickness measurement results from #6 to #10 in the present disclosure; and

FIG. 11 is a distribution diagram of thickness measurement results of the coating of the negative electrode sheet in embodiments 8 to 15 and comparative examples 6 to 10 in the present disclosure.

### DETAILED DESCRIPTION OF THE EMBODIMENTS

It is to be noted that embodiments and features in the embodiments in the present disclosure may be combined with each other without conflict. The present disclosure is described in detail below with reference to the accompanying drawings and in conjunction with the embodiments.

At present, in order to solve the problem of “thick edge” of the coating during the coating process, a commonly adopted strategy in the industry is to thin the edge of the electrode sheet during coating (see FIG. 3), which reduces the amount of coating in the edge area of the coating machine to form a thinning zone, so as to alleviate the problem of too large thickness of the edge of the coating after drying. Such method can effectively avoid the bulging edge phenomenon when the electrode sheet is wound up, as well as the problem of inconsistent transverse density due to uneven thickness during the roll pressing process. However, although such coating thinning method can eliminate the problem of thick edge of the electrode sheet, reduce the edge bulge of the electrode sheet and reduce the risk of breaking the belt of the electrode sheet, thinning leads to a reduction in the thickness of the edge area of the coating, which results in a reduction in the mass of the active material for the positive electrode sheet and a reduction in the capacity of the battery cell. At the same time, the degree of thinning is difficult to control, high equipment capacity is required, and the fluctuation of the thinning size is large in the production process. Thinning the edge of the negative electrode sheet may cause an N/P ratio to decrease, resulting in lithium precipitation at the edge, which directly affects the stability and safety of the battery cell. In addition, the thinning area may also lead to the formation of a certain gap between the roll core and the electrode sheet after winding, which makes the attachment of the electrode sheet not tight, leading to, in the battery in the charging and discharging process, lithium precipitation phenomenon due to the increase of local internal resistance, thereby affecting the performance of the battery. In general, the thinning of the electrode sheet is a design compromise to manufacturing to minimize the width of the thinning while meeting the need to eliminate the “thick edge.” Therefore, with respect to the problem of “thick edge” of the coating, the industry is more concerned about how to more finely control the thinning size, hoping to minimize the thinning size while eliminating the “thick edge.”

As described above, in the existing art, when solving the problem of “thick edge” of the coating during the coating process of forming the electrode sheet, it is difficult to take into account the electrical performance and safety performance of the battery cell. In order to solve this problem, embodiments of the present disclosure provide a secondary battery and a method for manufacturing the same.

In an exemplary embodiment of the present disclosure, there is provided a secondary battery including a battery cell. The battery cell includes a positive electrode, a negative electrode, a separator and an electrolyte. The negative electrode includes a negative current collector, and a negative electrode material coating laminated to a surface of the negative current collector. The negative electrode material coating is obtained by a negative electrode slurry coated on the surface of the negative current collector and then sequentially dried and compacted, and the negative electrode slurry includes: 96 to 98 parts by weight of a negative electrode active material; 0.6 to 1.2 parts by weight of a conductive agent; 1 to 2.5 parts by weight of a binder; 0.5 to 1.5 parts by weight of a dispersant; and 80 to 100 parts by weight of a solvent. The solvent includes a first solvent and a second solvent, the first solvent is water, the second solvent is an organic solvent and has a boiling point of 110° C. to 210° C. and a surface tension of 20 dyn/cm to 50 dyn/cm, and a mass ratio of the second solvent to the first solvent is 1:10 to 1:2. In some embodiments, the negative electrode slurry further includes 1.5 to 3 parts by weight of a thickener.

A solvent blending method is adopted to solve the problem of “thick edge” of the coating, that is, an organic solvent having a lower surface tension and a higher boiling point than water is introduced to be blended with water to prepare the negative electrode slurry. In the solvent blending method derived from the intrinsic mechanism of the formation of “thick edge” of the coating, the solvent having the lower surface tension and the higher boiling point than water is blended with water firstly, and then the double-solvent slurry is baked so that the second solvent has a higher concentration at the edge than at the middle in the drying process due to its higher boiling point, whereby a surface tension gradient is formed from the inside to the edge of the coating, inducing slurry particles at the edge to move toward the inside of the coating, which counteracts the effect of capillary action in the formation of “thick edge,” i.e., counteracting the edge aggregation effect brought about by the capillary action, thus solving the problem of “thick edge” of the coating. However, the introduction of the solvent with the lower surface tension results in a lower viscosity of the slurry, which causes a decrease in the spreadability of the slurry and is not favorable to the elimination of the “thick edge.” Therefore, in view of the above problem, the present disclosure further adds a thickener on the basis of the blending solvent, reducing the amount of the low surface tension solvent while ensuring the viscosity of the slurry, and thus playing a significant role in eliminating the “thick edge” of the coating under the above dual effect. Compared with the thinning method, the method of eliminating the thick edge in the present disclosure is not only easy to operate, but also improves the energy density of the battery cell and reduces the risk of lithium precipitation at the edge of the electrode sheet, thereby significantly improving the stability and safety performance of the battery cell. In addition, since the first solvent and the second solvent of the above type are blended solvent of organic solvent and water, the blended solvent is more suitably used as the solvent of the negative electrode slurry, so as to make various components of the negative electrode slurry more fully dispersed therein to obtain a homogeneous negative electrode slurry.

In one embodiment of the present disclosure, the boiling point of the second solvent is 10° C. to 110° C. higher than a boiling point of water. Additionally and/or alternatively, the surface tension of the second solvent is 15 dyn/cm to 50 dyn/cm lower than a surface tension of water.

The second solvent having the above differences in boiling point and surface tension from the first solvent is conductive to minimizing the negative effect of the reduction in viscosity of the slurry caused by the second solvent on the basis of achieving the purpose of inducing slurry particles at the edge to move toward the inside of the coating by using the second solvent. Specifically, if the second solvent has a too high boiling point compared with water, it is difficult for the solvent to evaporate off; and if the second solvent has a too low boiling point compared with water, the viscosity of the negative electrode slurry is too low to realize the coating of the negative electrode slurry on the collector. In an embodiment, the boiling point of the second solvent is 50° C. to 100° C. higher than the boiling point of water. For example, the boiling point of the second solvent is 50° C., 60° C., 70° C., 80° C., 90° C., or 100° C. higher than the boiling point of water, but is not limited to the listed values, and other unlisted values within the range of 10° C. to 110° C. are also applicable. If the surface tension of the second solvent is higher than the surface tension of water, the problem of “thick edge” of the negative electrode coating cannot be solved; and if the surface tension of the second solvent is too low compared with the surface tension of water, the viscosity of the negative electrode slurry is too low, and it is difficult to implement the coating of the negative electrode slurry. In an embodiment, the surface tension of the second solvent is 20 to 45 dyn/cm lower than the surface tension of water, for example, the surface tension of the second solvent is 20 dyn/cm, 25 dyn/cm, 30 dyn/cm, 35 dyn/cm, 40 dyn/cm, or 45 dyn/cm lower than the surface tension of water, but is not limited to the listed values, and other unlisted values within the range of 15 dyn/cm to 50 dyn/cm are also applicable.

In one embodiment of the present disclosure, the second solvent has 15 to 30 parts by weight. In an embodiment, the second solvent is selected from any one or more of ethylene glycol, ethylenediamine, butanol, acetic acid, propylene glycol and methyl formamide.

If the proportion of the second solvent is too low, a surface tension gradient of the slurry from the edge to the middle is too small, resulting in the coating prone to the problem of “thick edge.” If the proportion of the second solvent is too high, the baking temperature required in the coating process is relatively high, which easily causes problems such as cracking of the coating and increases the cost. In an embodiment, the second solvent has the type and proportion as described above. In an embodiment, the second solvent has 20 to 30 parts by weight. For example, the second solvent has 20 parts by weight, 21 parts by weight, 22 parts by weight, 23 parts by weight, 24 parts by weight, 25 parts by weight, 26 parts by weight, 27 parts by weight, 28 parts by weight, 29 parts by weight or 30 parts by weight, but is not limited to the listed values, and other unlisted values within the range of 15 to 30 parts by weight are also applicable. In an embodiment, the second solvent is selected from any one or more of ethylene glycol, propylene glycol and methyl formamide, so as to minimize the amount of the second solvent while inducing slurry particles at the edge to move toward the inside of the coating, thereby moderating the reducing effect of the second solvent on the slurry viscosity.

In one embodiment of the present disclosure, a mass ratio of the thickener to the second solvent is 1:20 to 1:5. Additionally and/or alternatively, the thickener is selected from any one or more of polyethylene glycol, polyacrylate, and hydroxyethyl cellulose. In an embodiment, the polyethylene glycol has a molecular weight of less than 600. Additionally and/or alternatively, the negative electrode slurry has a viscosity of 6000 Pa·s to 9000 Pa·s.

The mass ratio of the thickener to the second solvent within the above range is conductive to not only forming a surface tension gradient from the inside to the edge in the coating by the second solvent to induce slurry particles at the edge to move toward the inside of the coating, but also making up for, by means of the thickener, the deficiency of the reduced slurry viscosity due to the second solvent, thereby enabling the above two aspects to be fully taken into account, so that the effect of the second solvent is optimized, thereby playing a significant role in eliminating “thick edge” of the coating. In an embodiment, the mass ratio of the thickener to the second solvent is 1:15 to 1:10. For example, the mass ratio of the thickener to the second solvent is 1:15, 1:14, 1:13, 1:12, 1:11, or 1:10, but is not limited to the listed values, and other unlisted values in the range of 1:20 to 1:5 are also applicable. In an embodiment, the molecular weight of the polyethylene glycol is less than 400. For example, the molecular weight of the polyethylene glycol is 200, 300, or 400, but is not limited to the listed values, and other unlisted values in the range of less than 600 are also applicable. In an embodiment, the viscosity of the negative electrode slurry is 6500 Pa·s to 8500 Pa·s. For example, the viscosity of the negative electrode slurry is 6500 Pa·s, 7000 Pa·s, 7500 Pa·s, 8000 Pa·s, or 8500 Pa·s, but is not limited to the values listed, and other unlisted values in the range of 6000 Pa·s to 9000 Pa·s are also applicable.

In one embodiment of the present disclosure, the negative electrode active material is selected from any one or more of graphite, a silicon material, a silicon carbon material, and hard carbon. Additionally and/or alternatively, the conductive agent is selected from any one or more of a SP (Super-P) conductive agent, carbon black, carbon nanotubes, graphene. Additionally and/or alternatively, the binder is at least one of an SBR (styrene butadiene rubber) binder and a PAA (polyacrylic acid) binder. Additionally and/or alternatively, the dispersant is a CMC (carboxymethyl cellulose) dispersant.

The above negative electrode active material, conductive agent, binder and dispersant are more compatible with the above types of solvents, thus reducing the risk of “thick edges” of the entire negative electrode slurry during the coating process.

Further, in order to improve the synergistic cooperation effect of the components in the negative electrode slurry, in one embodiment of the present disclosure, the negative electrode slurry includes 96 to 97 parts by weight of graphite, 0.8 to 1.0 parts by weight of a SP conductive agent, 2 to 2.5 parts by weight of a SBR binder, 1.2 to 1.5 parts by weight of a CMC dispersant, 15 to 30 parts by weight of ethylene glycol, 60 to 75 parts by weight of deionized water, and 2 to 3 parts by weight of polyethylene glycol. For example, the negative electrode slurry includes 96 parts by weight, 96.5 parts by weight or 97 parts by weight of graphite; the SP conductive agent has 0.8 parts by weight, 0.9 parts by weight, or 1 parts by weight; the SBR binder has 2.1 parts by weight, 2.2 parts by weight, 2.3 parts by weight, or 2.5 parts by weight; and the CMC dispersant has 1.2 parts by weight, 1.3 parts by weight, 1.4 parts by weight, or 1.5 parts by weight. In an embodiment, ethylene glycol has 20 to 30 parts by weight. For example, ethylene glycol has 20 parts by weight, 21 parts by weight, 22 parts by weight, 23 parts by weight, 24 parts by weight, 25 parts by weight, 26 parts by weight, 27 parts by weight, 28 parts by weight, 29 parts by weight, or 30 parts by weight. In an embodiment, the deionized water has 65 to 75 parts by weight. For example, the deionized water has 65 parts by weight, 66 parts by weight, 67 parts by weight, 68 parts by weight, 69 parts by weight, 70 parts by weight, 71 parts by weight, 72 parts by weight, 73 parts by weight, 74 parts by weight, or 75 parts by weight. In an embodiment, the polyethylene glycol has 2 parts by weight, 2.5 parts by weight, or 3 parts by weight. The amounts of the above components are not limited to the values listed, and other unlisted values in the respective ranges are also applicable.

In one embodiment of the present disclosure, in a width direction of the negative electrode material coating, the negative electrode material coating includes an intermediate zone and an edge transition zone disposed on each of both sides of the intermediate zone, a thickness of the edge transition zone gradually decreases in a direction away from the intermediate zone, the intermediate zone has a thickness of H1, and the edge transition zone has a width of L2 in the direction away from the intermediate zone, wherein L2/H1 is 0.004 to 0.01:1.

In an embodiment, L2/H1 is in the range of 0.004 to 0.01:1, for example, 0.004:1, 0.005:1, 0.006:1, 0.007:1, 0.008:1, 0.009:1, or 0.01:1, but is not limited to the listed values, and other unlisted values within the above range are also applicable. Compared with the thinning process in the existing art, the value of L2/H1 within the above range facilitates making the battery cell have higher safety and energy density while avoiding the problem of “thick edge” of the coating.

Further, in order to improve the adaptability of the actual battery cell in the above embodiments so as to make the battery cell have excellent electrical performance, in one embodiment of the present disclosure, L2 is 1 mm to 2 mm, and H1 is 200 mm to 230 mm.

Further, in order to improve the adaptability of the actual battery cell in the above embodiment so as to make the battery cell have excellent electrical performance, in one embodiment of the present disclosure, L2 is 1 mm to 2 mm, for example, 1 mm, 1.1 mm, 1.2 mm, 1.3 mm, 1.4 mm, 1.5 mm, 1.6 mm, 1.7 mm, 1.8 mm, 1.9 mm, or 2 mm, but is not limited to the listed values, and other unlisted values within the above range are also applicable. H1 is 200 mm to 230 mm, for example, 210 mm, 215 mm, 220 mm, 225 mm, or 230 mm, but is not limited to the listed values, and other unlisted values within the above range are also applicable.

In addition, by changing the types of the first solvent and the second solvent described above and combining the first solvent and the second solvent, it is also possible to make the first solvent and the second solvent suitable for use as solvents for the positive electrode slurry, thereby enabling components of the positive electrode slurry to be more fully dispersed therein to obtain a homogeneous positive electrode slurry, and solving the problem of “thick edge” of the coating in the coating process of the positive electrode sheet.

In another exemplary embodiment of the present disclosure, there is provided a method for preparing the aforementioned secondary battery. The method includes: preparing a negative electrode slurry, coating the negative electrode slurry on a negative current collector, and then drying and compacting the negative electrode slurry to form the negative electrode material coating, thereby obtaining the negative electrode; preparing a positive electrode slurry, coating the positive electrode slurry on a positive electrode collector, and then drying and compacting the positive electrode slurry, thereby obtaining the positive electrode; and assembling the positive electrode, the negative electrode, a separator and an electrolyte to obtain a secondary battery, where preparing the negative electrode slurry includes: blending a negative electrode active material, a conductive agent, a binder, a dispersant, a solvent, and a thickener to obtain the negative electrode slurry. In some embodiments, blending the negative electrode active material, the conductive agent, the binder, the dispersant, the solvent, and the thickener to obtain the negative electrode slurry includes: in operation S1, dry blending a negative electrode active material, a conductive agent and a dispersant to obtain a dry blend; in operation S2, kneading the dry blend with a part of the first solvent to obtain a kneaded material; in operation S3, subjecting the kneaded material, the remaining part of the first solvent, the second solvent to a first wet blending to obtain a first wet blend; in operation S4, subjecting the first wet blend, a thickener and a binder to a second wet blending to obtain the negative electrode slurry. A sum of an amount of the part of the first solvent and an amount of the remaining part of the first solvent is a total amount of the first solvent. An amount of the negative electrode active material is 96 to 98 parts by weight, an amount of the conductive agent is 0.6 to 1.2 parts by weight, an amount of the binder is 1 to 2.5 parts by weight, an amount of the dispersant is 0.5 to 1.5 parts by weight, an amount of a solvent is 80 to 100 parts by weight, and an amount of the thickener is 1.5 to 3 parts by weight. The solvent includes the first solvent and the second solvent, the first solvent is water, the second solvent is an organic solvent, the second solvent has a boiling point of 110° C. to 210° C. and a surface tension of 20 dyn/cm to 50 dyn/cm, and a mass ratio of the second solvent to the first solvent is 1:10 to 1:2.

The above operation-by-operation blending process makes the components in the negative electrode slurry more uniformly blended, which makes the coating formed after the slurry is coated more uniform, makes the elimination of the problem of “thick edge” of the coating more significant, and in turn makes the battery cell have excellent electrical properties.

In one embodiment of the present disclosure, in the above operation S1, stirring parameters in the dry blending process include: a rotational speed of 15 rpm to 25 rpm, a stirring speed of 500 rpm to 800 rpm, and a stirring time of 30 min to 60 min.

Additionally/alternatively, in the operation S2, the kneading time is 60 min to 80 min, and stirring parameters in the kneading process include: a rotational speed of 20 rpm to 25 rpm, and a stirring speed of 300 rpm to 500 rpm. Additionally/alternatively, in the operation S3, stirring parameters in the first wet blending process include: a rotational speed of 22 rpm to 25 rpm, a stirring speed of 1000 rpm to 1500 rpm, and a stirring time of 90 min to 120 min. Additionally/alternatively, in the operation S4, stirring parameters in the second wet blending process include: a rotational speed of 22 rpm to 25 rpm, a stirring speed of 300 rpm to 600 rpm, and a stirring time of 30 min to 40 min.

The control of the stirring parameters in the above respective blending operations makes it possible to obtain a better blending effect with adaptable stirring parameters after the addition of the respective components, thereby obtaining a uniform negative electrode slurry, which in turn ensures the rolling uniformity of the electrode sheet in the rolling process, reduces the stress concentration of the electrode sheet due to uneven rolling, and effectively alleviates undesirable problems such as the rolling wavy edge of the electrode sheet. At the same time, the coating obtained by this method has a uniform thickness, so that in the subsequent assembly process, the fit between the electrode sheets is greatly improved, which significantly improves the performance of the battery cell. In an embodiment, in the stirring parameters in the dry blending process in the operation S1, the rotational speed is 15 rpm, 20 rpm, or 25 rpm, the stirring speed is 500 rpm, 600 rpm, 700 rpm, or 800 rpm, and the stirring time is 30 min, 40 min, 50 min, or 60 min. In an embodiment, in the operation S2, the kneading time is 60 min, 70 min or 80 min, and in the stirring parameters in the kneading process, the rotational speed is 20 rpm, 21 rpm, 22 rpm, 23 rpm, 24 rpm or 25 rpm, and the stirring speed is 300 rpm, 400 rpm or 500 rpm. In an embodiment, in the stirring parameters in the first wet blending process in the operation S3, the rotational speed is 22 rpm, 23 rpm, 24 rpm or 25 rpm, the stirring speed is 1000 rpm, 1100 rpm, 1200 rpm, 1300 rpm, 1400 rpm or 1500 rpm, and the stirring time is 90 min, 100 min, 110 min or 120 min. In an embodiment, in the stirring parameters in the second wet blending process in the operation S4, the rotational speed is 22 rpm, 23 rpm, 24 rpm, or 25 rpm, the stirring speed is 300 rpm, 400 rpm, 500 rpm, or 600 rpm, and the stirring time is 30 min, 35 min, or 40 min. The above stirring parameters are not limited to the listed values, and other unlisted values within the above respective ranges are also applicable.

The beneficial effects of the present disclosure are described below in conjunction with embodiments and comparative examples.

A preferred ratio of the first solvent to the second solvent is studied, as shown in Table 1.

TABLE 1

| Testing | | | | | | | | | |
|---|---|---|---|---|---|---|---|---|---|
| Serial | | | | | | | | | |
| number of | Graphite | Conductive | | | Ethylene | | Deionized | | Polyethylene |
| solvent | powder | agent | SBR | CMC | glycol | | water | | glycol |
| #1 | 96 parts | 0.8 parts | 2 parts | 1.2 parts | 8.18 | parts | 81.82 | parts | 0 parts |
| #2 | 96 parts | 0.8 parts | 2 parts | 1.2 parts | 15 | parts | 75 | parts | 0 parts |
| #3 | 96 parts | 0.8 parts | 2 parts | 1.2 parts | 20.77 | parts | 69.23 | parts | 0 parts |
| #4 | 96 parts | 0.8 parts | 2 parts | 1.2 parts | 25.71 | parts | 64.29 | parts | 0 parts |
| #5 | 96 parts | 0.8 parts | 2 parts | 1.2 parts | 30 | parts | 60 | parts | 0 parts |

The components (in parts by weight) in #1 to #5 were blended with reference to the following blending process to obtain negative electrode slurries of #1 to #5.

The above amounts of graphite powder, conductive agent and dispersant were put into a blending tank and dry blended for 30 min, with a rotational speed of 15 rpm and a stirring speed of 500 rpm. Then, 50 parts of deionized water were added into the blending tank to perform kneading and blending for 60 min, with a rotational speed of 20 rpm and a stirring speed of 300 rpm. Subsequently, the second solvent and the remaining parts of deionized water were added into the blending tank to perform high-speed dispersing, with a rotational speed of 22 rpm and a stirring speed of 1000 rpm. Finally, the binder was further added into the blending tank to continue the stirring for 30 min, with a rotational speed of 22 rpm and a stirring speed of 500 rpm, thereby obtaining the resulting negative electrode slurries of #1 to #5.

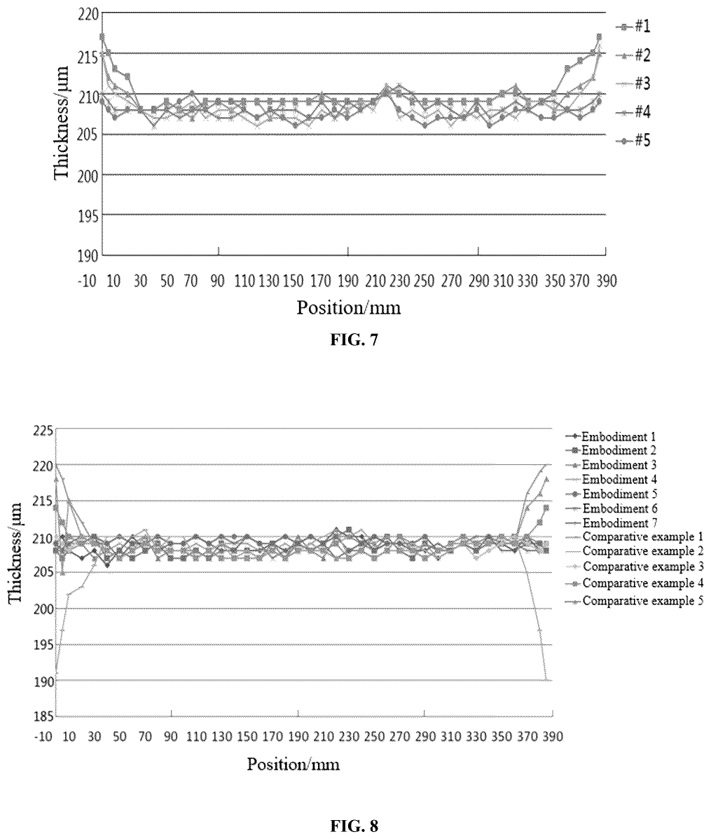

Coating: According to the design requirements of the battery cell, each of the negative electrode slurries of #1 to #5 was coated on a copper foil to obtain negative electrode sheets of #1 to #5, where the distribution of thickness measurements of the negative electrode sheets of #1 to #5 is shown in FIG. 7, and thicknesses of the negative electrode sheets of #1 to #5 at different positions are shown in Table 2, where P represents a positon, and T represents a thickness.

TABLE 2

| #1 | | #2 | | #3 | | #4 | | #5 | |
|---|---|---|---|---|---|---|---|---|---|
| P/ | T/ | P/ | T/ | P/ | T/ | P/ | T/ | P/ | T/ |
| mm | μm | mm | μm | mm | μm | mm | μm | mm | μm |
| 0 | 217 | 0 | 215 | 0 | 215 | 0 | 210 | 0 | 209 |
| 5 | 215 | 5 | 212 | 5 | 211 | 5 | 209 | 5 | 208 |
| 10 | 213 | 10 | 211 | 10 | 210 | 10 | 208 | 10 | 207 |
| 20 | 212 | 20 | 210 | 20 | 209 | 20 | 208 | 20 | 208 |
| 30 | 208 | 30 | 208 | 30 | 208 | 30 | 208 | 30 | 208 |
| 40 | 208 | 40 | 208 | 40 | 207 | 40 | 206 | 40 | 208 |
| 50 | 209 | 50 | 209 | 50 | 207 | 50 | 208 | 50 | 208 |
| 60 | 208 | 60 | 208 | 60 | 208 | 60 | 207 | 60 | 209 |
| 70 | 208 | 70 | 207 | 70 | 209 | 70 | 208 | 70 | 210 |
| 80 | 209 | 80 | 209 | 80 | 207 | 80 | 208 | 80 | 208 |
| 90 | 209 | 90 | 209 | 90 | 208 | 90 | 207 | 90 | 209 |
| 100 | 209 | 100 | 208 | 100 | 208 | 100 | 207 | 100 | 209 |
| 110 | 209 | 110 | 209 | 110 | 207 | 110 | 208 | 110 | 208 |
| 120 | 209 | 120 | 209 | 120 | 206 | 120 | 207 | 120 | 207 |
| 130 | 209 | 130 | 207 | 130 | 207 | 130 | 208 | 130 | 208 |
| 140 | 209 | 140 | 209 | 140 | 207 | 140 | 208 | 140 | 207 |
| 150 | 209 | 150 | 209 | 150 | 207 | 150 | 208 | 150 | 206 |
| 160 | 209 | 160 | 209 | 160 | 206 | 160 | 207 | 160 | 207 |
| 170 | 209 | 170 | 210 | 170 | 208 | 170 | 209 | 170 | 207 |
| 180 | 209 | 180 | 209 | 180 | 207 | 180 | 207 | 180 | 208 |
| 190 | 209 | 190 | 208 | 190 | 208 | 190 | 209 | 190 | 207 |
| 200 | 209 | 200 | 209 | 200 | 209 | 200 | 208 | 200 | 208 |
| 210 | 209 | 210 | 209 | 210 | 208 | 210 | 209 | 210 | 209 |
| 220 | 210 | 220 | 211 | 220 | 211 | 220 | 210 | 220 | 210 |
| 230 | 210 | 230 | 210 | 230 | 207 | 230 | 211 | 230 | 208 |
| 240 | 209 | 240 | 209 | 240 | 208 | 240 | 210 | 240 | 207 |
| 250 | 209 | 250 | 209 | 250 | 207 | 250 | 208 | 250 | 206 |
| 260 | 209 | 260 | 209 | 260 | 208 | 260 | 209 | 260 | 207 |
| 270 | 209 | 270 | 209 | 270 | 206 | 270 | 208 | 270 | 207 |
| 280 | 209 | 280 | 209 | 280 | 208 | 280 | 207 | 280 | 207 |
| 290 | 209 | 290 | 209 | 290 | 207 | 290 | 209 | 290 | 208 |
| 300 | 209 | 300 | 209 | 300 | 208 | 300 | 207 | 300 | 206 |
| 310 | 210 | 310 | 210 | 310 | 208 | 310 | 208 | 310 | 207 |
| 320 | 210 | 320 | 211 | 320 | 207 | 320 | 209 | 320 | 208 |
| 330 | 209 | 330 | 209 | 330 | 209 | 330 | 208 | 330 | 208 |
| 340 | 209 | 340 | 209 | 340 | 209 | 340 | 209 | 340 | 207 |
| 350 | 210 | 350 | 208 | 350 | 208 | 350 | 209 | 350 | 207 |
| 360 | 213 | 360 | 210 | 360 | 208 | 360 | 208 | 360 | 208 |
| 370 | 214 | 370 | 211 | 370 | 210 | 370 | 208 | 370 | 207 |
| 380 | 215 | 380 | 212 | 380 | 212 | 380 | 209 | 380 | 208 |
| 385 | 217 | 385 | 215 | 385 | 216 | 385 | 210 | 385 | 209 |

Combined with Table 1 and FIG. 7, it can be seen that the preferred mass ratio of ethylene glycol to deionized water is 1:10 to 1:2.

On the basis of the preferred mass ratio of ethylene glycol to deionized water of 1:10 to 1:2, the effect of the thickener on the coating thickness of the negative electrode sheet was studied, as shown in Table 3.

TABLE 3

| Embodiment | Graphite | Conductive | | | Ethylene | | Deionized | | Polyethylene | |
|---|---|---|---|---|---|---|---|---|---|---|
| serial number | powder | agent | SBR | CMC | glycol | | water | | glycol | |
| Embodiment 1 | 96 parts | 0.8 parts | 2 parts | 1.2 parts | 25.71 | parts | 64.29 | parts | 1.5 | parts |
| Embodiment 2 | 96 parts | 0.8 parts | 2 parts | 1.2 parts | 20.77 | parts | 69.23 | parts | 2 | parts |
| Embodiment 3 | 96 parts | 0.8 parts | 2 parts | 1.2 parts | 17.29 | parts | 72.1 | parts | 2.5 | parts |
| Embodiment 4 | 96 parts | 0.8 parts | 2 parts | 1.2 parts | 15 | parts | 75 | parts | 3 | parts |

The components in the embodiments 1 to 4 were blended with reference to the following blending process to obtain the negative electrode slurries in the embodiments 1 to 4.

The above amounts of graphite powder, conductive agent and dispersant were put into a blending tank and dry blended for 30 min, with a rotational speed of 15 rpm and a stirring speed of 500 rpm. Then, 50 parts of deionized water were added into the blending tank to perform kneading and stirring for 60 min, with a rotational speed of 20 rpm and a stirring speed of 300 rpm. Subsequently, the second solvent and the remaining parts of deionized water were added into the blending tank to perform high-speed dispersing, with a rotational speed of 22 rpm and a stirring speed of 1000 rpm. Finally, the thickener and the binder were further added into the blending tank to continue the stirring for 30 min, with a rotational speed of 22 rpm and a stirring speed of 500 rpm, thereby obtaining the resulting negative electrode slurries of embodiments 1 to 4.

Coating: According to the design requirements of the battery cell, each of the negative electrode slurries of embodiments 1 to 4 was coated on a copper foil to obtain negative electrode sheets of embodiments 1 to 4.

### Embodiment 5

Embodiment 5 differs from embodiment 2 in that the second solvent is methyl formamide, which has a boiling point 82.5° C. higher than the boiling point of deionized water and a surface tension 13.62 dyn/cm lower than the surface tension of water, thereby obtaining the resulting the negative electrode sheet.

### Embodiment 6

Embodiment 6 differs from embodiment 2 in that: the above amounts of graphite powder, conductive agent and dispersant were put into the blending tank and dry blended for 60 min, with a rotational speed of 25 rpm and a stirring speed of 800 rpm. Then, 50 parts of deionized water were added into the blending tank to perform kneading and stirring for 80 min, with a rotational speed of 25 rpm and a stirring speed of 500 rpm. Subsequently, the second solvent and the remaining parts of deionized water were added into the blending tank to perform high-speed dispersing for 120 min, with a rotational speed of 25 rpm and a stirring speed of 1500 rpm. Finally, the thickener and the binder were further added into the blending tank to continue the stirring for 40 min, with a rotational speed of 25 rpm and a stirring speed of 300 rpm. In this way, the negative electrode slurry of embodiment 6 is obtained, and then the resulting negative electrode sheet is obtained.

### Embodiment 7

Embodiment 7 differs from embodiment 2 in that the negative electrode slurry includes 96 parts by weight of a silicon material (a negative electrode active material), 0.8 parts by weight of a SP conductive agent, 2 parts by weight of a SBR binder, 1.2 parts by weight of a CMC dispersant, 25.71 parts by weight of ethylene glycol (a second solvent), 64.29 parts by weight of deionized water, and 1.5 parts by weight of polyethylene glycol (a thickener), thereby obtaining the resulting negative electrode sheet.

### Comparative Example 1

### Preparation of a Negative Electrode Slurry:

Raw materials of the negative electrode slurry were weighed according to the following weight parts: 96 parts by weight of graphite powder (a negative electrode active material), 0.8 parts by weight of a SP conductive agent, 2 parts by weight of a SBR binder, 1.2 parts by weight of a CMC dispersant, and 90 parts by weight of deionized water.

The above amounts of graphite powder, conductive agent and dispersant were put into a blending tank and dry blended for 30 min, with a rotational speed of 15 rpm and a stirring speed of 500 rpm. Then, 50 parts of deionized water were added into the blending tank to perform kneading and stirring for 60 min, with a rotational speed of 20 rpm and a stirring speed of 300 rpm. Subsequently, the second solvent and the remaining parts of deionized water were added into the blending tank to perform high-speed dispersing, with a rotational speed of 22 rpm and a stirring speed of 1000 rpm. Finally, the binder was further added into the blending tank to continue the stirring for 30 min, with a rotational speed of 22 rpm and a stirring speed of 500 rpm. In this way, the negative electrode slurry of comparative example 1 is obtained.

### Coating:

According to the design requirements of the battery cell, the negative electrode slurry of comparative example 1 was coated on a copper foil to obtain the negative electrode sheet of comparative example 1.

### Comparative Example 2

### Negative Electrode Slurry Preparation:

The negative electrode slurry of comparative example 2 was prepared according to the slurry preparation process of the comparative example 1.

### Coating:

According to the design requirements of the battery cell, the negative electrode slurry of comparative example 2 was coated on a copper foil, and the edge was thinned during the coating process to obtain the negative electrode sheet of comparative example 2.

### Comparative Example 3

Comparative example 3 differs from embodiment 2 in that: the total parts by weight of ethylene glycol (a second solvent) and deionized water are 90, where a mass ratio of ethylene glycol to the deionized water is 3:1, thereby obtaining the resulting negative electrode sheet.

### Comparative Example 4

Comparative example 4 differs from embodiment 2 in that: the total parts by weight of ethylene glycol (a second solvent) and deionized water are 90, where a mass ratio of ethylene glycol to the deionized water is 11:1, thereby obtaining the resulting negative electrode sheet.

### Comparative Example 5

Comparative example 5 differs from embodiment 1 in that: the second solvent is ethyl alcohol (with a boiling point of 78.5° C., and a surface tension of 24.05 dyn/cm), and the resulting negative electrode sheet is obtained.

The distribution of thickness measurements of the negative electrode sheets of embodiments 1 to 7 and comparative examples 1 to 5 is shown in FIG. 8, thicknesses of the negative electrode sheets of embodiments 1 to 6 at different positions are shown in Table 4, and thicknesses of the negative electrode sheets of embodiment 7 and comparative examples 1 to 5 at different positions are shown in Table 5, where P represents a positon, and T represents a thickness.

TABLE 4

| Embodiment 1 | | Embodiment 2 | | Embodiment 3 | | Embodiment 4 | | Embodiment 5 | | Embodiment 6 | |
|---|---|---|---|---|---|---|---|---|---|---|---|
| P/ | T/ | P/ | T/ | P/ | T/ | P/ | T/ | P/ | T/ | P/ | T/ |
| mm | μm | mm | μm | mm | μm | mm | μm | mm | μm | mm | μm |
| 0 | 209 | 0 | 208 | 0 | 208 | 0 | 209 | 0 | 209 | 0 | 208 |
| 5 | 210 | 5 | 207 | 5 | 208 | 5 | 208 | 5 | 208 | 5 | 209 |
| 10 | 208 | 10 | 208 | 10 | 209 | 10 | 208 | 10 | 210 | 10 | 209 |
| 20 | 207 | 20 | 209 | 20 | 209 | 20 | 209 | 20 | 210 | 20 | 210 |
| 30 | 208 | 30 | 210 | 30 | 207 | 30 | 210 | 30 | 210 | 30 | 209 |
| 40 | 206 | 40 | 207 | 40 | 208 | 40 | 208 | 40 | 209 | 40 | 209 |
| 50 | 208 | 50 | 208 | 50 | 207 | 50 | 209 | 50 | 210 | 50 | 207 |
| 60 | 210 | 60 | 207 | 60 | 209 | 60 | 208 | 60 | 209 | 60 | 209 |
| 70 | 208 | 70 | 208 | 70 | 210 | 70 | 210 | 70 | 209 | 70 | 209 |
| 80 | 209 | 80 | 209 | 80 | 207 | 80 | 209 | 80 | 210 | 80 | 210 |
| 90 | 207 | 90 | 207 | 90 | 208 | 90 | 208 | 90 | 209 | 90 | 209 |
| 100 | 207 | 100 | 207 | 100 | 208 | 100 | 208 | 100 | 209 | 100 | 209 |
| 110 | 208 | 110 | 208 | 110 | 208 | 110 | 209 | 110 | 210 | 110 | 210 |
| 120 | 207 | 120 | 207 | 120 | 207 | 120 | 208 | 120 | 209 | 120 | 209 |
| 130 | 208 | 130 | 209 | 130 | 208 | 130 | 209 | 130 | 210 | 130 | 210 |
| 140 | 208 | 140 | 208 | 140 | 208 | 140 | 209 | 140 | 210 | 140 | 209 |
| 150 | 208 | 150 | 208 | 150 | 208 | 150 | 209 | 150 | 210 | 150 | 210 |
| 160 | 208 | 160 | 207 | 160 | 207 | 160 | 208 | 160 | 209 | 160 | 209 |
| 170 | 209 | 170 | 209 | 170 | 209 | 170 | 208 | 170 | 209 | 170 | 207 |
| 180 | 208 | 180 | 207 | 180 | 207 | 180 | 209 | 180 | 210 | 180 | 208 |
| 190 | 209 | 190 | 209 | 190 | 210 | 190 | 208 | 190 | 209 | 190 | 209 |
| 200 | 208 | 200 | 208 | 200 | 208 | 200 | 209 | 200 | 210 | 200 | 210 |
| 210 | 209 | 210 | 209 | 210 | 207 | 210 | 208 | 210 | 209 | 210 | 209 |
| 220 | 211 | 220 | 210 | 220 | 210 | 220 | 209 | 220 | 210 | 220 | 210 |
| 230 | 210 | 230 | 211 | 230 | 210 | 230 | 210 | 230 | 208 | 230 | 208 |
| 240 | 210 | 240 | 209 | 240 | 209 | 240 | 211 | 240 | 209 | 240 | 208 |
| 250 | 208 | 250 | 208 | 250 | 209 | 250 | 209 | 250 | 210 | 250 | 210 |
| 260 | 209 | 260 | 210 | 260 | 210 | 260 | 210 | 260 | 209 | 260 | 209 |
| 270 | 209 | 270 | 208 | 270 | 210 | 270 | 210 | 270 | 209 | 270 | 209 |
| 280 | 208 | 280 | 207 | 280 | 209 | 280 | 208 | 280 | 209 | 280 | 209 |
| 290 | 208 | 290 | 209 | 290 | 210 | 290 | 209 | 290 | 210 | 290 | 210 |
| 300 | 207 | 300 | 208 | 300 | 208 | 300 | 207 | 300 | 208 | 300 | 208 |
| 310 | 208 | 310 | 208 | 310 | 209 | 310 | 208 | 310 | 208 | 310 | 208 |
| 320 | 209 | 320 | 209 | 320 | 210 | 320 | 209 | 320 | 209 | 320 | 209 |
| 330 | 208 | 330 | 208 | 330 | 209 | 330 | 208 | 330 | 208 | 330 | 210 |
| 340 | 209 | 340 | 209 | 340 | 210 | 340 | 210 | 340 | 210 | 340 | 210 |
| 350 | 209 | 350 | 209 | 350 | 210 | 350 | 210 | 350 | 210 | 350 | 209 |
| 360 | 208 | 360 | 210 | 360 | 209 | 360 | 209 | 360 | 209 | 360 | 209 |
| 370 | 210 | 370 | 209 | 370 | 210 | 370 | 209 | 370 | 209 | 370 | 208 |
| 380 | 208 | 380 | 209 | 380 | 209 | 380 | 208 | 380 | 208 | 380 | 208 |
| 385 | 209 | 385 | 208 | 385 | 208 | 385 | 209 | 385 | 209 | 385 | 209 |

TABLE 5

| Embodiment | | Comparative | | Comparative | | Comparative | | Comparative | | Comparative | |
|---|---|---|---|---|---|---|---|---|---|---|---|
| 7 | | example 1 | | example 2 | | example 3 | | example 4 | | example 5 | |
| P/ | T/ | P/ | T/ | P/ | T/ | P/ | T/ | P/ | T/ | P/ | T/ |
| mm | μm | mm | μm | mm | μm | mm | μm | mm | μm | mm | μm |
| 0 | 209 | 0 | 220 | 0 | 191 | 0 | 210 | 0 | 214 | 0 | 218 |
| 5 | 208 | 5 | 218 | 5 | 197 | 5 | 209 | 5 | 212 | 5 | 205 |
| 10 | 210 | 10 | 215 | 10 | 202 | 10 | 208 | 10 | 210 | 10 | 215 |
| 20 | 209 | 20 | 212 | 20 | 203 | 20 | 210 | 20 | 209 | 20 | 210 |
| 30 | 210 | 30 | 209 | 30 | 206 | 30 | 209 | 30 | 209 | 30 | 209 |
| 40 | 209 | 40 | 208 | 40 | 210 | 40 | 208 | 40 | 208 | 40 | 208 |
| 50 | 210 | 50 | 207 | 50 | 210 | 50 | 207 | 50 | 207 | 50 | 207 |
| 60 | 209 | 60 | 208 | 60 | 210 | 60 | 208 | 60 | 208 | 60 | 208 |
| 70 | 209 | 70 | 209 | 70 | 211 | 70 | 209 | 70 | 209 | 70 | 209 |
| 80 | 208 | 80 | 208 | 80 | 208 | 80 | 208 | 80 | 208 | 80 | 208 |
| 90 | 209 | 90 | 208 | 90 | 210 | 90 | 208 | 90 | 208 | 90 | 208 |
| 100 | 209 | 100 | 208 | 100 | 210 | 100 | 208 | 100 | 208 | 100 | 208 |
| 110 | 210 | 110 | 207 | 110 | 207 | 110 | 207 | 110 | 207 | 110 | 207 |
| 120 | 209 | 120 | 208 | 120 | 208 | 120 | 208 | 120 | 208 | 120 | 208 |
| 130 | 208 | 130 | 207 | 130 | 209 | 130 | 207 | 130 | 207 | 130 | 207 |
| 140 | 208 | 140 | 207 | 140 | 207 | 140 | 207 | 140 | 207 | 140 | 207 |
| 150 | 210 | 150 | 207 | 150 | 208 | 150 | 207 | 150 | 207 | 150 | 207 |
| 160 | 209 | 160 | 207 | 160 | 207 | 160 | 207 | 160 | 207 | 160 | 207 |
| 170 | 209 | 170 | 208 | 170 | 208 | 170 | 208 | 170 | 208 | 170 | 208 |
| 180 | 210 | 180 | 207 | 180 | 207 | 180 | 207 | 180 | 207 | 180 | 207 |
| 190 | 209 | 190 | 208 | 190 | 208 | 190 | 208 | 190 | 208 | 190 | 208 |
| 200 | 210 | 200 | 208 | 200 | 209 | 200 | 208 | 200 | 208 | 200 | 208 |
| 210 | 209 | 210 | 208 | 210 | 210 | 210 | 208 | 210 | 208 | 210 | 208 |
| 220 | 207 | 220 | 207 | 220 | 211 | 220 | 207 | 220 | 209 | 220 | 207 |
| 230 | 208 | 230 | 207 | 230 | 207 | 230 | 207 | 230 | 207 | 230 | 207 |
| 240 | 209 | 240 | 208 | 240 | 208 | 240 | 208 | 240 | 208 | 240 | 208 |
| 250 | 210 | 250 | 207 | 250 | 207 | 250 | 207 | 250 | 207 | 250 | 207 |
| 260 | 209 | 260 | 208 | 260 | 208 | 260 | 208 | 260 | 208 | 260 | 208 |
| 270 | 209 | 270 | 208 | 270 | 208 | 270 | 208 | 270 | 210 | 270 | 208 |
| 280 | 209 | 280 | 208 | 280 | 209 | 280 | 208 | 280 | 208 | 280 | 208 |
| 290 | 208 | 290 | 207 | 290 | 208 | 290 | 207 | 290 | 207 | 290 | 207 |
| 300 | 209 | 300 | 208 | 300 | 207 | 300 | 208 | 300 | 208 | 300 | 208 |
| 310 | 208 | 310 | 209 | 310 | 208 | 310 | 209 | 310 | 209 | 310 | 209 |
| 320 | 209 | 320 | 209 | 320 | 209 | 320 | 209 | 320 | 210 | 320 | 209 |
| 330 | 208 | 330 | 209 | 330 | 207 | 330 | 207 | 330 | 209 | 330 | 209 |
| 340 | 210 | 340 | 209 | 340 | 208 | 340 | 208 | 340 | 209 | 340 | 209 |
| 350 | 208 | 350 | 210 | 350 | 209 | 350 | 209 | 350 | 210 | 350 | 210 |
| 360 | 208 | 360 | 209 | 360 | 210 | 360 | 210 | 360 | 209 | 360 | 209 |
| 370 | 209 | 370 | 216 | 370 | 205 | 370 | 209 | 370 | 210 | 370 | 214 |
| 380 | 209 | 380 | 219 | 380 | 197 | 380 | 208 | 380 | 212 | 380 | 216 |
| 385 | 208 | 385 | 220 | 385 | 190 | 385 | 209 | 385 | 214 | 385 | 218 |

### Performance Test:

Testing of thickness in a transverse direction (TD) of the electrode sheet: the thickness of the electrode sheet was measured along the TD direction of the electrode sheet after the coating at intervals of 5 mm using a universal ruler, and three values were measured at each point to find the average value, and the thicknesses of all the points were summarized and plotted.

The viscosity of the negative electrode slurry was tested by a rotational viscometer, and test results are shown in Table 6.

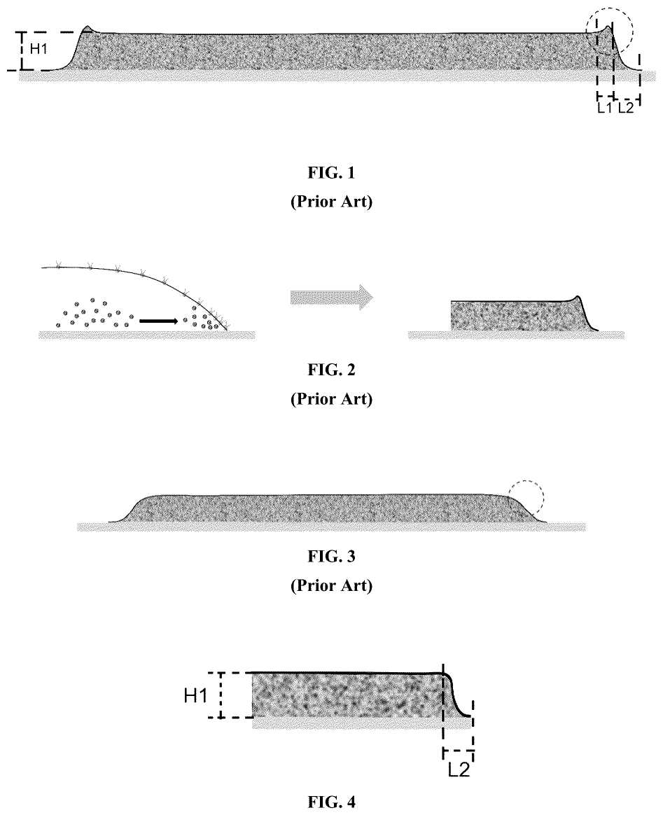

Testing of L1, L2, H1 and H2: a universal ruler was used to measure and calculate a ratio of L1 to H1 (i.e., L1/H1), and a ratio of L2 to H1 (i.e., L2/H1), and the results are shown in Table 6, in which L1 represents a width of a thick edge area of the negative electrode coating, and H2 represents a maximum thickness of the thick edge area of the negative electrode coating, as shown in FIG. 1.

A sodium iron phosphate positive electrode, a separator and a negative electrode sheet obtained from each of the above embodiments and the comparative examples are sequentially laminated, and then assembled into a battery cell by means of winding or stacking, and the battery cell is injected with electrolyte (lithium hexafluorophosphate and a solvent, where the solvent includes: vinyl carbonate, dimethyl carbonate, and methyl ethyl carbonate with a proportion of 1:1:1) inside the battery cell. The battery cell was put into the aluminum-plastic film, welded or laser-welded with battery tabs, and then subjected to sealing and formation to obtain a soft-packed lithium-ion battery with a nominal capacity of 2.3 Ah. The discharge specific capacity of the lithium-ion battery was tested at 0.5 P, and test results were listed in Table 6.

TABLE 6

| | Viscosity | | | | | | |
|---|---|---|---|---|---|---|---|
| | of | | | | | | Discharge |
| | negative | | | | | | specific |
| Embodiment/ | electrode | | | | | | capacity |
| Comparative | slurry | H2 | | L2 | H1 | | at 0.5 P |
| example | (Pa · s) | (μm) | L1/H1 | (μm) | (μm) | L2/H1 | (mAh) |
| Embodiment 1 | 6357 | 209 ± 1.5 | 0 | 100 ± 1 | 209 ± 1.5 | 0.48 | 2.35 |
| Embodiment 2 | 6963 | 209 ± 1.5 | 0 | 100 ± 1 | 209 ± 1.5 | 0.48 | 2.36 |
| Embodiment 3 | 7532 | 209 ± 1.5 | 0 | 100 ± 1 | 209 ± 1.5 | 0.48 | 2.33 |
| Embodiment 4 | 8015 | 209 ± 1.5 | 0 | 100 ± 1 | 209 ± 1.5 | 0.48 | 2.34 |
| Embodiment 5 | 8139 | 209 ± 1.5 | 0 | 100 ± 1 | 209 ± 1.5 | 0.48 | 2.33 |
| Embodiment 6 | 8391 | 209 ± 1.5 | 0 | 100 ± 1 | 209 ± 1.5 | 0.48 | 2.34 |
| Embodiment 7 | 8176 | 209 ± 1.5 | 0 | 100 ± 1 | 209 ± 1.5 | 0.48 | 2.35 |
| Comparative | 7654 | 220 ± 1.5 | 9.57 | 100 ± 1 | 209 ± 1.5 | 0.48 | / |
| example 1 | | | | | | | |
| Comparative | 7743 | / | / | / | 209 ± 1.5 | / | 2.34 |
| example 2 | | | | | | | |
| Comparative | 8276 | 209 ± 1.5 | 0 | 100 ± 1 | 209 ± 1.5 | 0.48 | 2.35 |
| example 3 | | | | | | | |
| Comparative | 6467 | 214 ± 1.5 | 4.78 | 100 ± 1 | 209 ± 1.5 | 0.48 | / |
| example 4 | | | | | | | |
| Comparative | 7487 | 218 ± 1.5 | 8.61 | 100 ± 1 | 209 ± 1.5 | 0.48 | / |
| example 5 | | | | | | | |

As can be seen from the data in Table 6, the methods of embodiments 1 to 7 not only solve the problem of “thick edge” of the coating, but also ensure that the lithium-ion battery has a high discharge capacity. In comparative example 2, there is a serious risk of lithium precipitation, which greatly reduces the cycle performance and safety performance of the lithium-ion battery. In comparative example 3, the baking temperature of the negative electrode sheet is higher due to the higher content of the second solvent, which results in serious surface cracking of the negative electrode sheet. Comparative examples 1, 4 and 5 do not solve the problem of “thick edge” of the coating.

As can be seen from the comparison between FIG. 1 and FIG. 4, the present disclosure solves the problem of “thick edge” of the negative electrode coating, i.e., the thick edge corresponding to L1 in FIG. 1 has disappeared in the negative electrode coating of the present disclosure

From the above description, it can be seen that the above embodiments of the present disclosure achieve technical effects described below.

A solvent blending method is adopted to solve the problem of “thick edge” of the coating, that is, an organic solvent having a lower surface tension and a higher boiling point than water is introduced to be blended with water to prepare the negative electrode slurry. In the solvent blending method derived from the intrinsic mechanism of the formation of “thick edge” of the coating, the solvent having the lower surface tension and the higher boiling point than water is blended with water firstly, and then the double-solvent slurry is baked so that the second solvent has a higher concentration at the edge than at the middle in the drying process due to its higher boiling point, whereby a surface tension gradient is formed from the inside to the edge of the coating, inducing slurry particles at the edge to move toward the inside of the coating, which counteracts the effect of capillary action in the formation of “thick edge,” i.e., counteracting the edge aggregation effect brought about by the capillary action, thus solving the problem of “thick edge” of the coating. However, the introduction of the solvent with the lower surface tension results in a lower viscosity of the slurry, which causes a decrease in the spreadability of the slurry and is not favorable to the elimination of the “thick edge.” Therefore, in view of the above problem, the present disclosure further adds a thickener on the basis of the blending solvent, reducing the amount of the low surface tension solvent while ensuring the viscosity of the slurry, and thus playing a significant role in eliminating the “thick edge” of the coating under the above dual effect. Compared with the thinning method, the method of eliminating the thick edge in the present disclosure is not only easy to operate, but also improves the energy density of the battery cell and reduces the risk of lithium precipitation at the edge of the electrode sheet, thereby significantly improving the stability and safety performance of the battery cell. In addition, since the first solvent and the second solvent of the above type are blended solvent of organic solvent and water, the blended solvent is more suitably used as the solvent of the negative electrode slurry, so as to make various components of the negative electrode slurry more fully dispersed therein to obtain a homogeneous negative electrode slurry.

As presently disclosed above, in the existing art, when solving the problem of “thick edge” of the coating in the coating process for forming the electrode sheet, there are problems of poor stability of the electrode sheet and the coating being prone to cracking, and in order to solve such problems, other embodiments of the present disclosure provides a secondary battery and a method for preparing the same.

In an exemplary embodiment of the present disclosure, a secondary battery is provided, including a battery cell. The battery cell includes a positive electrode, a negative electrode, a separator and an electrolyte. The negative electrode includes a negative current collector, and a negative electrode material coating laminated to a surface of the negative current collector. The negative electrode material coating is obtained by a negative electrode slurry coated on the surface of the negative current collector and then sequentially dried and compacted. The negative electrode slurry includes: 96 to 98 parts by weight of a negative electrode active material; 0.6 to 1.2 parts by weight of a conductive agent; 1 to 2.5 parts by weight of a binder; 0.5 to 1.5 parts by weight of a dispersant; 80 to 100 parts by weight of a solvent; and 2 to 5 parts by weight of a surfactant. In some embodiment, the surfactant is an anionic surfactant selected from any one or more of sodium lauryl sulfate, sodium dodecyl sulfate, sodium dodecyl benzene sulfonate, sodium stearate, and sodium fatty alcohol ether sulfate. In some embodiment, the solvent includes a first solvent and a second solvent, the first solvent is water, the second solvent is an organic solvent and has a boiling point of 110° C. to 210° C. and a surface tension of 20 dyn/cm to 50 dyn/cm, and a mass ratio of the second solvent to the first solvent is 1:10 to 1:2.

In the present disclosure, a solvent blending method is adopted, that is, an organic solvent having a lower surface tension and a higher boiling point than water is introduced to be blended with water to prepare the negative electrode slurry. In the solvent blending method derived from the intrinsic mechanism of the formation of “thick edge” of the coating, the solvent having the lower surface tension and the higher boiling point than water is blended with water firstly, and then the double-solvent slurry is baked so that the second solvent has a higher concentration at the edge than at the middle in the drying process due to its higher boiling point, whereby a surface tension gradient is formed from the inside to the edge of the coating, inducing slurry particles at the edge to move toward the inside of the coating, which counteracts the effect of capillary action in the formation of “thick edge,” i.e., counteracting the edge aggregation effect brought about by the capillary action, thus solving the problem of “thick edge” of the coating. However, the introduction of the solvent with the higher boiling point requires a higher baking temperature and a longer baking time to dry the electrode sheet, which makes the electrode sheet prone to cracking under the higher baking temperature and longer baking time. In view of the above problem, the present disclosure introduces a surfactant, and due to the role of hydrophilic and hydrophobic groups in the surfactant, the surfactant may form a uniform adsorption layer on the surface layer of the graphite particles, making the graphite particles as a whole negatively charged, and electrostatic interaction and steric hindrance generated by effective adsorption of the graphite particles effectively reduces the capillary effect, reduce the “thick edge” effect (that is, reducing aggregation of graphite particles at the edge), and reduce the amount of the solvent with the higher boiling point, so that the viscosity of the slurry is improved to be in an appropriate range (thereby eliminating the use of thickener), and then the coating baking temperature is reduced, which significantly improves the cracking problem of the slurry in the coating process, while reducing the energy consumption for baking and the costs. In addition, compared with the thinning method, the method of eliminating the thick edge in the present disclosure is not only simple to operate, but also capable of improving the energy density of the battery cell, reducing the risk of lithium precipitation at the edge of the electrode sheet, and ensuring the fit of the electrode sheet in the assembly process, thereby significantly improving the stability, safety and electrical performance of the battery cell.

In one embodiment of the present disclosure, in a width direction of the negative electrode material coating, the negative electrode material coating includes an intermediate zone and an edge transition zone disposed on each of both sides of the intermediate zone, a thickness of the edge transition zone gradually decreases in a direction away from the intermediate zone, the intermediate zone has a thickness of H1, and the edge transition zone has a width of L2 in the direction away from the intermediate zone, where L2/H1 is 0.004 to 0.01:1.

In an embodiment, L2/H1 is in the range of 0.004 to 0.01:1, for example, 0.004:1, 0.005:1, 0.006:1, 0.007:1, 0.008:1, 0.009:1, or 0.01:1, but is not limited to the listed values, and other unlisted values within the above range are also applicable. Compared with the thinning process in the existing art, the value of L2/H1 within the above range facilitates making the battery cell have higher safety and energy density while avoiding the problem of “thick edge” of the coating.

Further, in order to improve the adaptability of the actual battery cell in the above embodiments so as to make the battery cell have excellent electrical performance, in one embodiment of the present disclosure, L2 is 1 mm to 2 mm, for example, 1 mm, 1.1 mm, 1.2 mm, 1.3 mm, 1.4 mm, 1.5 mm, 1.6 mm, 1.7 mm, 1.8 mm, 1.9 mm, or 2 mm, but is not limited to the listed values, and other unlisted values within the above range are also applicable. H1 is 200 mm to 230 mm, for example, 210 mm, 215 mm, 220 mm, 225 mm, or 230 mm, but is not limited to the listed values, and other unlisted values within the above range are also applicable.

In addition, by changing the types of the first solvent and the second solvent described above and combining the first solvent and the second solvent, it is also possible to make the first solvent and the second solvent suitable for use as solvents for the positive electrode slurry, thereby enabling components of the positive electrode slurry to be more fully dispersed therein to obtain a homogeneous positive electrode slurry, and solving the problem of “thick edge” of the coating in the coating process of the positive electrode sheet.

In one embodiment of the present disclosure, the second solvent has 8 to 15 parts by weight. In an embodiment, the second solvent is selected from any one or more of ethylene glycol, ethylenediamine, butanol, acetic acid, propylene glycol and methyl formamide. In an embodiment, the second solvent is selected from any one or more of ethylene glycol, propylene glycol and methyl formamide

If the proportion of the second solvent is too low, a surface tension gradient of the slurry from the edge to the middle is too small, resulting in the coating prone to the problem of “thick edge.” If the proportion of the second solvent is too high, the baking temperature required in the coating process is relatively high, which easily causes problems such as cracking of the coating and increases the cost. In an embodiment, the second solvent has the type and proportion as described above. In an embodiment, the second solvent has 10 to 15 parts by weight. For example, the second solvent has 10 parts by weight, 11 parts by weight, 12 parts by weight, 13 parts by weight, 14 parts by weight, and 15 parts by weight, but is not limited to the listed values, and other unlisted values within the range of 8 to 15 parts by weight are also applicable. In an embodiment, the second solvent is selected from any one or more of ethylene glycol, propylene glycol and methyl formamide, so as to minimize the amount of the second solvent while inducing slurry particles at the edge to move toward the inside of the coating, thereby moderating the reducing effect of the second solvent on the slurry viscosity.

In one embodiment of the present disclosure, a mass ratio of the thickener to the second solvent is 3:20 to 5:8. Additionally and/or alternatively, the negative electrode slurry has a viscosity of 6000 Pa·s to 9000 Pa·s.

The mass ratio of the surfactant to the second solvent within the above range is conductive to not only forming a surface tension gradient from the inside to the edge in the coating by the second solvent to induce slurry particles at the edge to move toward the inside of the coating, but also making up for, by means of the surfactant, the deficiency of the reduced slurry viscosity due to the second solvent, thereby enabling the above two aspects to be fully taken into account, so that the effect of the second solvent is optimized, thereby playing a significant role in eliminating “thick edge” of the coating. At the same time, the dosage of the second solvent is reduced to a large extent, so that the viscosity of the negative electrode slurry is increased to the range of 6000 Pa·s to 9000 Pa·s, and then the baking temperature of the coating is reduced. In an embodiment, a mass ratio of the surfactant to the second solvent is 1:15 to 1:10, for example, 1:15, 1:14, 1:13, 1:12, 1:11, or 1:10, but is not limited to the listed values, and other unlisted values in the range of 3:20 to 5:8 are also applicable. In an embodiment, the viscosity of the negative electrode slurry is 6500 Pa·s to 8500 Pa·s. For example, the viscosity of the negative electrode slurry is 6500 Pa·s, 7000 Pa·s, 7500 Pa·s, 8000 Pa·s, or 8500 Pa·s, but is not limited to the values listed, and other unlisted values in the range of 6000 Pa·s to 9000 Pa·s are also applicable.

In one embodiment of the present disclosure, the negative electrode active material is selected from any one or more of graphite, a silicon material, a silicon carbon material, and hard carbon. Additionally and/or alternatively, the conductive agent is selected from any one or more of a SP (Super-P) conductive agent, carbon black, carbon nanotubes, graphene. Additionally and/or alternatively, the binder is at least one of an SBR (styrene butadiene rubber) binder and a PAA (polyacrylic acid) binder. Additionally and/or alternatively, the dispersant is a CMC (carboxymethyl cellulose) dispersant.

The above negative electrode active material, conductive agent, binder and dispersant are more compatible with the above types of solvents, thus reducing the risk of “thick edges” of the entire negative electrode slurry during the coating process.

Further, in order to improve the synergistic cooperation effect of the components in the negative electrode slurry, in one embodiment of the present disclosure, the negative electrode slurry includes 96 to 97 parts by weight of graphite, 0.8 to 1.0 parts by weight of a SP conductive agent, 2 to 2.5 parts by weight of a SBR binder, 1.2 to 1.5 parts by weight of a CMC dispersant, 8 to 30 parts by weight of ethylene glycol, 70 to 92 parts by weight of deionized water, and 3 to 4 parts by weight of sodium dodecyl sulfate. For example, the negative electrode slurry includes 96 parts by weight, 96.5 parts by weight or 97 parts by weight of graphite; the SP conductive agent has 0.8 parts by weight, 0.9 parts by weight, or 1 parts by weight; the SBR binder has 2.1 parts by weight, 2.2 parts by weight, 2.3 parts by weight, or 2.5 parts by weight; and the CMC dispersant has 1.2 parts by weight, 1.3 parts by weight, 1.4 parts by weight, or 1.5 parts by weight.

In an embodiment, ethylene glycol has 10 to 30 parts by weight. For example, ethylene glycol has 10 parts by weight, 12 parts by weight, 14 parts by weight, 16 parts by weight, 18 parts by weight, 20 parts by weight, 22 parts by weight, 24 parts by weight, 26 parts by weight, 28 parts by weight, or 30 parts by weight. In an embodiment, the deionized water has 75 to 85 parts by weight. For example, the deionized water has 75 parts by weight, 76 parts by weight, 77 parts by weight, 78 parts by weight, 79 parts by weight, 80 parts by weight, 81 parts by weight, 82 parts by weight, 83 parts by weight, 84 parts by weight, or 85 parts by weight. In an embodiment, the polyethylene glycol has 3 parts by weight, 3.5 parts by weight, or 4 parts by weight. The amounts of the above components are not limited to the values listed, and other unlisted values in the respective ranges are also applicable.

In one embodiment of the present disclosure, the boiling point of the second solvent is 10° C. to 110° C. higher than a boiling point of water. Additionally and/or alternatively, the surface tension of the second solvent is 15 dyn/cm to 50 dyn/cm lower than a surface tension of water. Additionally and/or, the water is deionized water.

The second solvent having the above differences in boiling point and surface tension from the first solvent is conductive to minimizing the negative effect of the reduction in viscosity of the slurry caused by the second solvent on the basis of achieving the purpose of inducing slurry particles at the edge to move toward the inside of the coating by using the second solvent. Specifically, if the second solvent has a too high boiling point compared with water, it is difficult for the solvent to evaporate off; and if the second solvent has a too low boiling point compared with water, the viscosity of the negative electrode slurry is too low to realize the coating of the negative electrode slurry on the collector. In an embodiment, the boiling point of the second solvent is 50° C. to 100° C. higher than the boiling point of water. For example, the boiling point of the second solvent is 50° C., 60° C., 70° C., 80° C., 90° C., or 100° C. higher than the boiling point of water, but is not limited to the listed values, and other unlisted values within the range of 10° C. to 110° C. are also applicable. If the surface tension of the second solvent is higher than the surface tension of water, the problem of “thick edge” of the negative electrode coating cannot be solved; and if the surface tension of the second solvent is too low compared with the surface tension of water, the viscosity of the negative electrode slurry is too low, and it is difficult to implement the coating of the negative electrode slurry. Therefore, in an embodiment, the surface tension of the second solvent is 20 to 45 dyn/cm lower than the surface tension of water, for example, the surface tension of the second solvent is 20 dyn/cm, 25 dyn/cm, 30 dyn/cm, 35 dyn/cm, 40 dyn/cm, or 45 dyn/cm lower than the surface tension of water, but is not limited to the listed values, and other unlisted values within the range of 15 dyn/cm to 50 dyn/cm are also applicable.

In another exemplary embodiment of the present disclosure, there is provided a method for preparing the aforementioned secondary battery. The method includes: preparing a negative electrode slurry, coating the negative electrode slurry on a negative current collector, and then drying and compacting the negative electrode slurry, to obtain a negative electrode; preparing a positive electrode slurry, coating the positive electrode slurry on a positive electrode collector, and then drying and compacting the positive electrode slurry, to obtain a positive electrode; and assembling the positive electrode, the negative electrode, a separator and an electrolyte to obtain a secondary battery, where the operation of preparing the negative electrode slurry includes: in operation S1, dry blending a negative electrode active material, a conductive agent and a dispersant to obtain a dry blend; in operation S2, kneading the dry blend with a part of the first solvent to obtain a kneaded material; in operation S3, subjecting the kneaded material, the remaining part of the first solvent, the second solvent to a first wet blending to obtain a first wet blend; in operation S4, subjecting the first wet blend and a surfactant to a second wet blending to obtain a second wet blend; in operation S5, subjecting the second wet blend and a binder to a third wet blending to obtain the negative electrode slurry. A sum of an amount of the part of the first solvent and an amount of the remaining part of the first solvent is a total amount of the first solvent.

The above operation-by-operation blending process makes the components in the negative electrode slurry more uniformly blended, which makes the coating formed after the slurry is coated more uniform, makes the elimination effect of the problem of “thick edge” of the coating more significant, and in turn makes the battery cell have excellent electrical properties.

In one embodiment of the present disclosure, in the above operation S1, stirring parameters in the dry blending process include: a rotational speed of 15 rpm to 25 rpm, a stirring speed of 500 rpm to 800 rpm, and a stirring time of 30 min to 60 min. Additionally/alternatively, in the operation S2, the kneading time is 60 min to 80 min, and stirring parameters in the kneading process include: a rotational speed of 20 rpm to 25 rpm, and a stirring speed of 300 rpm to 500 rpm. Additionally/alternatively, in the operation S3, stirring parameters in the first wet blending process include: a rotational speed of 22 rpm to 25 rpm, a stirring speed of 1000 rpm to 1500 rpm, and a stirring time of 90 min to 120 min. Additionally/alternatively, in the operation S4, stirring parameters in the second wet blending process include: a rotational speed of 22 rpm to 25 rpm, a stirring speed of 500 rpm to 1000 rpm, and a stirring time of 60 min to 90 min. Additionally/alternatively, in the operation S4, stirring parameters in the third wet blending process include: a rotational speed of 22 rpm to 25 rpm, a stirring speed of 300 rpm to 600 rpm, and a stirring time of 30 min to 40 min.

The control of the stirring parameters in the above respective blending operations makes it possible to obtain a better blending effect with adaptable stirring parameters after the addition of the respective components, thereby obtaining a uniform negative electrode slurry, which in turn ensures the rolling uniformity of the electrode sheet in the rolling process, reduces the stress concentration of the electrode sheet due to uneven rolling, and effectively alleviates undesirable problems such as the rolling wavy edge of the electrode sheet. At the same time, the coating obtained by this method has a uniform thickness, so that in the subsequent assembly process, the fit between the electrode sheets is greatly improved, which significantly improves the performance of the battery cell. In an embodiment, in the stirring parameters in the dry blending process in the operation S1, the rotational speed is 15 rpm, 20 rpm, or 25 rpm, the stirring speed is 500 rpm, 600 rpm, 700 rpm, or 800 rpm, and the stirring time is 30 min, 40 min, 50 min, or 60 min. In an embodiment, in the operation S2, the kneading time is 60 min, 70 min or 80 min, and in the stirring parameters in the kneading process, the rotational speed is 20 rpm, 21 rpm, 22 rpm, 23 rpm, 24 rpm or 25 rpm, and the stirring speed is 300 rpm, 400 rpm or 500 rpm. In an embodiment, in the stirring parameters in the first wet blending process in the operation S3, the rotational speed is 22 rpm, 23 rpm, 24 rpm or 25 rpm, the stirring speed is 1000 rpm, 1100 rpm, 1200 rpm, 1300 rpm, 1400 rpm or 1500 rpm, and the stirring time is 90 min, 100 min, 110 min or 120 min. In an embodiment, in the stirring parameters in the second wet blending process in the operation S4, the rotational speed is 22 rpm, 23 rpm, 24 rpm, or 25 rpm, the stirring speed is 500 rpm, 600 rpm, 700 rpm, or 800 rpm, and the stirring time is 60 min, 70 min, 80 min, or 90 min. In an embodiment, in the stirring parameters in the second wet blending process in the operation S5, the rotational speed is 22 rpm, 23 rpm, 24 rpm, or 25 rpm, the stirring speed is 300 rpm, 400 rpm, 500 rpm, or 600 rpm, and the stirring time is 30 min, 35 min, or 40 min. The above stirring parameters are not limited to the listed values, and other unlisted values within the above respective ranges are also applicable.

The beneficial effects of the present disclosure are described below in conjunction with embodiments and comparative examples.

A preferred ratio of the first solvent to the second solvent is studied, as shown in Table 7.

TABLE 7

| Testing | | | | | | | | | |
|---|---|---|---|---|---|---|---|---|---|
| Serial | | SP | | | | | | | sodium |
| number of | Graphite | conductive | | | Ethylene | | Deionized | | dodecyl |
| solvent | powder | agent | SBR | CMC | glycol | | water | | sulfate |
| #6 | 96 parts | 0.8 parts | 2 parts | 1.2 parts | 8.18 | parts | 81.82 | parts | 0 parts |
| #7 | 96 parts | 0.8 parts | 2 parts | 1.2 parts | 15 | parts | 75 | parts | 0 parts |
| #8 | 96 parts | 0.8 parts | 2 parts | 1.2 parts | 20.77 | parts | 69.23 | parts | 0 parts |
| #9 | 96 parts | 0.8 parts | 2 parts | 1.2 parts | 25.71 | parts | 64.29 | parts | 0 parts |
| #10 | 96 parts | 0.8 parts | 2 parts | 1.2 parts | 30 | parts | 60 | parts | 0 parts |

The components in #6 to #10 were blended with reference to the following blending process to obtain negative electrode slurries of #6 to #10.

The above amounts of graphite powder, conductive agent and dispersant were put into a blending tank and dry blended for 30 min, with a rotational speed of 15 rpm and a stirring speed of 500 rpm. Then, 50 parts of deionized water were added into the blending tank to perform kneading and blending for 60 min, with a rotational speed of 20 rpm and a stirring speed of 300 rpm. Subsequently, the second solvent and the remaining parts of deionized water were added into the blending tank to perform high-speed dispersing, with a rotational speed of 22 rpm and a stirring speed of 1000 rpm. Finally, the binder was further added into the blending tank to continue the stirring for 30 min, with a rotational speed of 22 rpm and a stirring speed of 500 rpm, thereby obtaining the resulting negative electrode slurries of #6 to #10.

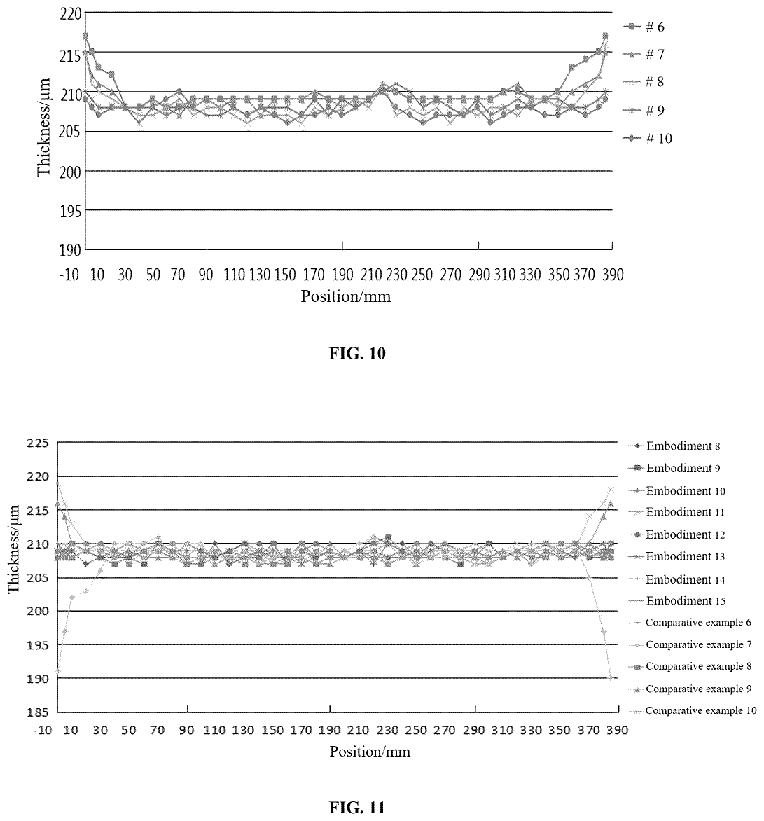

Coating: According to the design requirements of the battery cell, each of the negative electrode slurries of #6 to #10 was coated on a copper foil to obtain negative electrode sheets of #6 to #10, where the distribution of thickness measurements of the negative electrode sheets of #6 to #10 is shown in FIG. 10, and thicknesses of the negative electrode sheets of #6 to #10 at different positions are shown in Table 8.

TABLE 8

| #1 | | #2 | | #3 | | #4 | | #5 | |
|---|---|---|---|---|---|---|---|---|---|
| Position/ | Thickness/ | Position/ | Thickness/ | Position/ | Thickness/ | Position/ | Thickness/ | Position/ | Thickness/ |
| mm | μm | mm | μm | mm | μm | mm | μm | mm | μm |
| 0 | 217 | 0 | 215 | 0 | 215 | 0 | 210 | 0 | 209 |
| 5 | 215 | 5 | 212 | 5 | 211 | 5 | 209 | 5 | 208 |
| 10 | 213 | 10 | 211 | 10 | 210 | 10 | 208 | 10 | 207 |
| 20 | 212 | 20 | 210 | 20 | 209 | 20 | 208 | 20 | 208 |
| 30 | 208 | 30 | 208 | 30 | 208 | 30 | 208 | 30 | 208 |
| 40 | 208 | 40 | 208 | 40 | 207 | 40 | 206 | 40 | 208 |
| 50 | 209 | 50 | 209 | 50 | 207 | 50 | 208 | 50 | 208 |
| 60 | 208 | 60 | 208 | 60 | 208 | 60 | 207 | 60 | 209 |
| 70 | 208 | 70 | 207 | 70 | 209 | 70 | 208 | 70 | 210 |
| 80 | 209 | 80 | 209 | 80 | 207 | 80 | 208 | 80 | 208 |
| 90 | 209 | 90 | 209 | 90 | 208 | 90 | 207 | 90 | 209 |
| 100 | 209 | 100 | 208 | 100 | 208 | 100 | 207 | 100 | 209 |
| 110 | 209 | 110 | 209 | 110 | 207 | 110 | 208 | 110 | 208 |
| 120 | 209 | 120 | 209 | 120 | 206 | 120 | 207 | 120 | 207 |
| 130 | 209 | 130 | 207 | 130 | 207 | 130 | 208 | 130 | 208 |
| 140 | 209 | 140 | 209 | 140 | 207 | 140 | 208 | 140 | 207 |
| 150 | 209 | 150 | 209 | 150 | 207 | 150 | 208 | 150 | 206 |
| 160 | 209 | 160 | 209 | 160 | 206 | 160 | 207 | 160 | 207 |
| 170 | 209 | 170 | 210 | 170 | 208 | 170 | 209 | 170 | 207 |
| 180 | 209 | 180 | 209 | 180 | 207 | 180 | 207 | 180 | 208 |
| 190 | 209 | 190 | 208 | 190 | 208 | 190 | 209 | 190 | 207 |
| 200 | 209 | 200 | 209 | 200 | 209 | 200 | 208 | 200 | 208 |
| 210 | 209 | 210 | 209 | 210 | 208 | 210 | 209 | 210 | 209 |
| 220 | 210 | 220 | 211 | 220 | 211 | 220 | 210 | 220 | 210 |
| 230 | 210 | 230 | 210 | 230 | 207 | 230 | 211 | 230 | 208 |
| 240 | 209 | 240 | 209 | 240 | 208 | 240 | 210 | 240 | 207 |
| 250 | 209 | 250 | 209 | 250 | 207 | 250 | 208 | 250 | 206 |
| 260 | 209 | 260 | 209 | 260 | 208 | 260 | 209 | 260 | 207 |
| 270 | 209 | 270 | 209 | 270 | 206 | 270 | 208 | 270 | 207 |
| 280 | 209 | 280 | 209 | 280 | 208 | 280 | 207 | 280 | 207 |
| 290 | 209 | 290 | 209 | 290 | 207 | 290 | 209 | 290 | 208 |
| 300 | 209 | 300 | 209 | 300 | 208 | 300 | 207 | 300 | 206 |
| 310 | 210 | 310 | 210 | 310 | 208 | 310 | 208 | 310 | 207 |
| 320 | 210 | 320 | 211 | 320 | 207 | 320 | 209 | 320 | 208 |
| 330 | 209 | 330 | 209 | 330 | 209 | 330 | 208 | 330 | 208 |
| 340 | 209 | 340 | 209 | 340 | 209 | 340 | 209 | 340 | 207 |
| 350 | 210 | 350 | 208 | 350 | 208 | 350 | 209 | 350 | 207 |
| 360 | 213 | 360 | 210 | 360 | 208 | 360 | 208 | 360 | 208 |
| 370 | 214 | 370 | 211 | 370 | 210 | 370 | 208 | 370 | 207 |
| 380 | 215 | 380 | 212 | 380 | 212 | 380 | 209 | 380 | 208 |
| 385 | 217 | 385 | 215 | 385 | 216 | 385 | 210 | 385 | 209 |

Combined with Table 8 and FIG. 10, it can be seen that the preferred mass ratio of ethylene glycol to deionized water is 1:10 to 1:2.

On the basis of the preferred mass ratio of ethylene glycol to deionized water of 1:10 to 1:2, the effect of the thickener on the coating thickness of the negative electrode sheet was studied, as shown in Table 9.

TABLE 9

| Embodiment | | | | | | | | | Sodium |
|---|---|---|---|---|---|---|---|---|---|
| serial | Graphite | Conductive | | | Ethylene | | Deionized | | dodecyl |
| number | powder | agent | SBR | CMC | glycol | | water | | sulfate |
| Embodiment 8 | 96 parts | 0.8 parts | 2 parts | 1.2 parts | 25.71 | parts | 64.29 | parts | 2 parts |
| Embodiment 9 | 96 parts | 0.8 parts | 2 parts | 1.2 parts | 20.77 | parts | 69.23 | parts | 3 parts |
| Embodiment 10 | 96 parts | 0.8 parts | 2 parts | 1.2 parts | 17.29 | parts | 72.1 | parts | 3 parts |
| Embodiment 11 | 96 parts | 0.8 parts | 2 parts | 1.2 parts | 15 | parts | 75 | parts | 4 parts |
| Embodiment 12 | 96 parts | 0.8 parts | 2 parts | 1.2 parts | 8.18 | parts | 81.82 | parts | 5 parts |

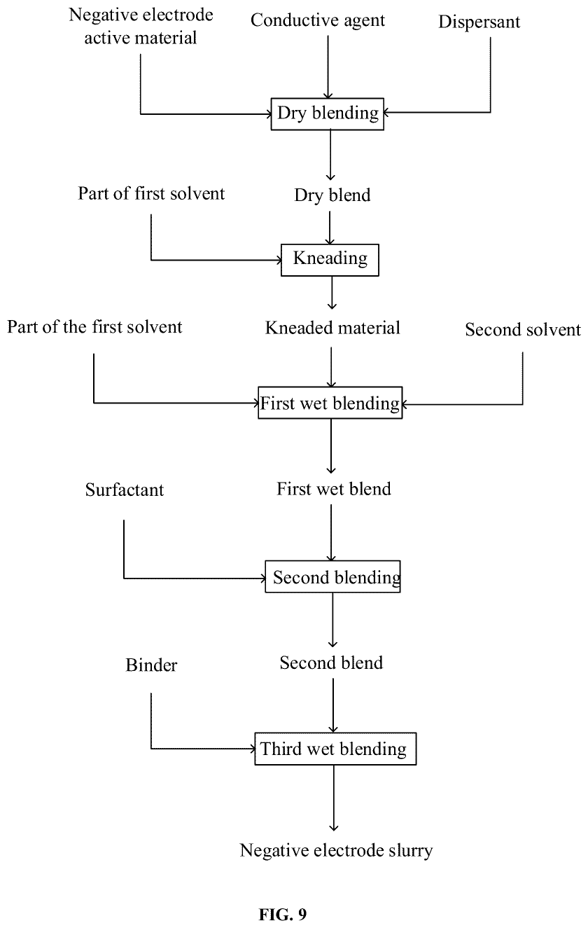

The components in the embodiments 8 to 12 were blended with reference to the following blending process (also with reference to the flowchart of the process for preparing the negative electrode slurry shown in FIG. 9) to obtain the negative electrode slurries in the embodiments 8 to 12.

The above amounts of graphite powder, conductive agent and dispersant were put into a blending tank and dry blended for 30 min, with a rotational speed of 15 rpm and a stirring speed of 500 rpm. Then, 50 parts of deionized water were added into the blending tank to perform kneading and stirring for 60 min, with a rotational speed of 20 rpm and a stirring speed of 300 rpm. Subsequently, the second solvent and the remaining parts of deionized water were added into the blending tank to perform high-speed dispersing, with a rotational speed of 22 rpm and a stirring speed of 1000 rpm. Subsequently, Sodium dodecyl sulfate was further added into the blending tank to perform stirring for 60 min, with a rotational speed of 22 rpm and a stirring speed of 1000 rpm. Finally, the binder was further added into the blending tank to continue the stirring for 30 min, with a rotational speed of 22 rpm and a stirring speed of 500 rpm, thereby obtaining the resulting negative electrode slurries of embodiments 8 to 12.

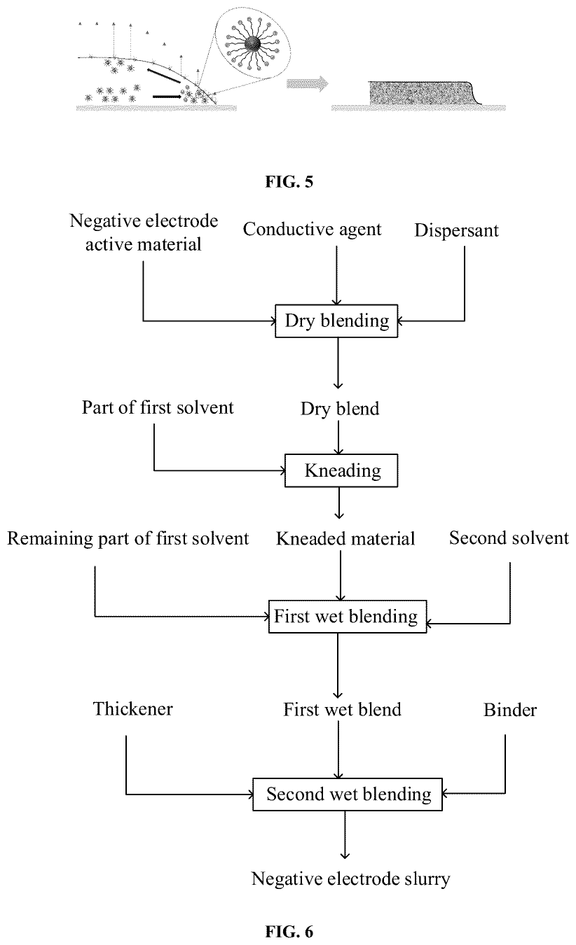

Coating: According to the design requirements of the battery cell, each of the negative electrode slurries of embodiments 8 to 12 was coated on a copper foil to obtain negative electrode sheets of embodiments 8 to 12, where a schematic diagram of the edge of the coating formed during the coating process in embodiment 12 is shown in FIG. 4, and a drying principle of the negative electrode coating in embodiment 12 is shown in FIG. 5.

### Embodiment 13

Embodiment 13 differs from embodiment 10 in that the second solvent is methyl formamide, which has a boiling point 82.5° C. higher than the boiling point of deionized water and a surface tension 13.62 dyn/cm lower than the surface tension of water, thereby obtaining the resulting the negative electrode sheet.

### Embodiment 14

Embodiment 14 differs from embodiment 10 in that: the above amounts of graphite powder, conductive agent and dispersant were put into the blending tank and dry blended for 60 min, with a rotational speed of 25 rpm and a stirring speed of 800 rpm. Then, 50 parts of deionized water were added into the blending tank to perform kneading and stirring for 80 min, with a rotational speed of 25 rpm and a stirring speed of 500 rpm. Subsequently, the second solvent and the remaining parts of deionized water were added into the blending tank to perform high-speed dispersing for 120 min, with a rotational speed of 25 rpm and a stirring speed of 1500 rpm. Subsequently, sodium dodecyl sulfate was further added into the blending tank to perform stirring for 90 min, with a rotational speed of 25 rpm and a stirring speed of 500 rpm. Finally, the binder was further added into the blending tank to continue the stirring for 40 min, with a rotational speed of 25 rpm and a stirring speed of 300 rpm, thereby obtaining the resulting negative electrode sheet.

### Embodiment 15

Embodiment 15 differs from embodiment 10 in that the negative electrode slurry includes 96 parts by weight of a silicon material (a negative electrode active material), 0.8 parts by weight of a SP conductive agent, 2 parts by weight of a SBR binder, 1.2 parts by weight of a CMC dispersant, 25.71 parts by weight of ethylene glycol (a second solvent), 64.29 parts by weight of deionized water, and 1.5 parts by weight of sodium dodecyl sulfate, thereby obtaining the resulting negative electrode sheet.

### Comparative Example 6

### Preparation of a Negative Electrode Slurry:

Raw materials of the negative electrode slurry were weighed according to the following weight parts: 96 parts by weight of graphite powder (a negative electrode active material), 0.8 parts by weight of a SP conductive agent, 2 parts by weight of a SBR binder, 1.2 parts by weight of a CMC dispersant, 20.77 parts by weight of ethylene glycol (a second solvent), 69.23 parts by weight of deionized water, and 2 parts by weight of polyethylene glycol.

The above amounts of graphite powder, conductive agent and dispersant were put into a blending tank and dry blended for 30 min, with a rotational speed of 15 rpm and a stirring speed of 500 rpm. Then, 50 parts of deionized water were added into the blending tank to perform kneading and stirring for 60 min, with a rotational speed of 20 rpm and a stirring speed of 300 rpm. Subsequently, the second solvent and the remaining parts of deionized water were added into the blending tank to perform high-speed dispersing, with a rotational speed of 22 rpm and a stirring speed of 1000 rpm. Finally, the thickener and the binder were further added into the blending tank to continue the stirring for 30 min, with a rotational speed of 22 rpm and a stirring speed of 500 rpm, thereby obtaining the resulting negative electrode slurry of comparative example 6.

### Coating:

According to the design requirements of the battery cell, the negative electrode slurry of comparative example 6 was coated on a copper foil to obtain the negative electrode sheet of comparative example 6.

### Comparative Example 7

### Preparation of a Negative Electrode Slurry:

Raw materials of the negative electrode slurry were weighed according to the following weight parts: 96 parts by weight of graphite powder (a negative electrode active material), 0.8 parts by weight of a SP conductive agent, 2 parts by weight of a SBR binder, 1.2 parts by weight of a CMC dispersant, and 90 parts by weight of deionized water.

The above amounts of graphite powder, conductive agent and dispersant were put into a blending tank and dry blended for 30 min, with a rotational speed of 15 rpm and a stirring speed of 500 rpm. Then, 50 parts of deionized water were added into the blending tank to perform kneading and stirring for 60 min, with a rotational speed of 20 rpm and a stirring speed of 300 rpm. Subsequently, the second solvent and the remaining parts of deionized water were added into the blending tank to perform high-speed dispersing, with a rotational speed of 22 rpm and a stirring speed of 1000 rpm. Finally, the binder was further added into the blending tank to continue the stirring for 30 min, with a rotational speed of 22 rpm and a stirring speed of 500 rpm, thereby obtaining, the negative electrode slurry of comparative example 7.

### Coating:

According to the design requirements of the battery cell, the negative electrode slurry of comparative example 7 was coated on a copper foil, and the edge was thinned during the coating process to obtain the negative electrode sheet of comparative example 7, a schematic diagram of the edge of the coating shown in FIG. 3.

### Comparative Example 8

Comparative example 8 differs from embodiment 8 in that: the total parts by weight of ethylene glycol and deionized water are 90, where a mass ratio of ethylene glycol to the deionized water is 3:1, thereby obtaining the resulting negative electrode sheet.

### Comparative Example 9

Comparative example 9 differs from embodiment 8 in that: the total weight parts by weight of ethylene glycol and deionized water are 90, where a mass ratio of ethylene glycol to the deionized water is 11:1, and then the resulting negative electrode sheet is obtained.

### Comparative Example 10

Comparative example 10 differs from embodiment 8 in that: the second solvent is ethyl alcohol (with a boiling point of 78.5° C., and a surface tension of 24.05 dyn/cm), and the resulting negative electrode sheet is obtained.

The distribution of thickness measurements of the negative electrode sheets of embodiments 8 to 15 and comparative examples 6 to 10 is shown in FIG. 11. Thicknesses of the negative electrode sheets of embodiments 8 to 14 at different positions are shown in table 10, and thicknesses of the negative electrode sheets of embodiment 15 and comparative examples 6 to 10 at different positions are shown in table 11, where P represents a positon, and T represents a thickness.

TABLE 10

| Embodiment 8 | | Embodiment 9 | | Embodiment 10 | | Embodiment 11 | | Embodiment 12 | | Embodiment 13 | | Embodiment 14 | |
|---|---|---|---|---|---|---|---|---|---|---|---|---|---|
| P/ | T/ | P/ | T/ | P/ | T/ | P/ | T/ | P/ | T/ | P/ | T/ | P/ | T/ |
| mm | μm | mm | μm | mm | μm | mm | μm | mm | μm | mm | μm | mm | μm |
| 0 | 209 | 0 | 208 | 0 | 208 | 0 | 209 | 0 | 209 | 0 | 209 | 0 | 210 |
| 5 | 209 | 5 | 209 | 5 | 209 | 5 | 209 | 5 | 209 | 5 | 209 | 5 | 208 |
| 10 | 209 | 10 | 208 | 10 | 210 | 10 | 208 | 10 | 210 | 10 | 209 | 10 | 209 |
| 20 | 207 | 20 | 209 | 20 | 209 | 20 | 209 | 20 | 210 | 20 | 209 | 20 | 209 |
| 30 | 208 | 30 | 208 | 30 | 209 | 30 | 209 | 30 | 210 | 30 | 209 | 30 | 208 |
| 40 | 208 | 40 | 207 | 40 | 208 | 40 | 208 | 40 | 209 | 40 | 209 | 40 | 209 |
| 50 | 208 | 50 | 208 | 50 | 209 | 50 | 209 | 50 | 210 | 50 | 208 | 50 | 208 |
| 60 | 210 | 60 | 207 | 60 | 209 | 60 | 208 | 60 | 209 | 60 | 209 | 60 | 209 |
| 70 | 210 | 70 | 210 | 70 | 210 | 70 | 210 | 70 | 209 | 70 | 209 | 70 | 209 |
| 80 | 209 | 80 | 209 | 80 | 209 | 80 | 208 | 80 | 210 | 80 | 209 | 80 | 208 |
| 90 | 207 | 90 | 207 | 90 | 208 | 90 | 208 | 90 | 210 | 90 | 209 | 90 | 210 |
| 100 | 207 | 100 | 207 | 100 | 208 | 100 | 208 | 100 | 209 | 100 | 209 | 100 | 209 |
| 110 | 210 | 110 | 208 | 110 | 208 | 110 | 209 | 110 | 208 | 110 | 208 | 110 | 208 |
| 120 | 207 | 120 | 209 | 120 | 209 | 120 | 207 | 120 | 209 | 120 | 209 | 120 | 209 |
| 130 | 208 | 130 | 209 | 130 | 208 | 130 | 209 | 130 | 210 | 130 | 210 | 130 | 210 |
| 140 | 209 | 140 | 208 | 140 | 208 | 140 | 209 | 140 | 210 | 140 | 209 | 140 | 208 |
| 150 | 208 | 150 | 210 | 150 | 210 | 150 | 209 | 150 | 208 | 150 | 209 | 150 | 209 |
| 160 | 208 | 160 | 207 | 160 | 207 | 160 | 208 | 160 | 209 | 160 | 209 | 160 | 209 |
| 170 | 210 | 170 | 209 | 170 | 209 | 170 | 207 | 170 | 209 | 170 | 207 | 170 | 209 |
| 180 | 208 | 180 | 209 | 180 | 208 | 180 | 209 | 180 | 210 | 180 | 208 | 180 | 208 |
| 190 | 209 | 190 | 209 | 190 | 210 | 190 | 208 | 190 | 209 | 190 | 209 | 190 | 209 |
| 200 | 208 | 200 | 208 | 200 | 208 | 200 | 209 | 200 | 208 | 200 | 208 | 200 | 208 |
| 210 | 209 | 210 | 209 | 210 | 209 | 210 | 208 | 210 | 209 | 210 | 209 | 210 | 209 |
| 220 | 211 | 220 | 210 | 220 | 210 | 220 | 209 | 220 | 208 | 220 | 209 | 220 | 207 |
| 230 | 210 | 230 | 211 | 230 | 210 | 230 | 210 | 230 | 208 | 230 | 208 | 230 | 210 |
| 240 | 210 | 240 | 209 | 240 | 209 | 240 | 208 | 240 | 209 | 240 | 208 | 240 | 209 |
| 250 | 208 | 250 | 208 | 250 | 207 | 250 | 209 | 250 | 210 | 250 | 208 | 250 | 209 |
| 260 | 210 | 260 | 208 | 260 | 210 | 260 | 208 | 260 | 210 | 260 | 209 | 260 | 209 |
| 270 | 209 | 270 | 208 | 270 | 210 | 270 | 210 | 270 | 209 | 270 | 209 | 270 | 210 |
| 280 | 208 | 280 | 207 | 280 | 209 | 280 | 208 | 280 | 209 | 280 | 209 | 280 | 209 |
| 290 | 208 | 290 | 209 | 290 | 208 | 290 | 207 | 290 | 209 | 290 | 209 | 290 | 208 |
| 300 | 207 | 300 | 210 | 300 | 208 | 300 | 207 | 300 | 208 | 300 | 208 | 300 | 210 |
| 310 | 208 | 310 | 208 | 310 | 209 | 310 | 208 | 310 | 208 | 310 | 208 | 310 | 208 |
| 320 | 209 | 320 | 209 | 320 | 208 | 320 | 209 | 320 | 209 | 320 | 209 | 320 | 209 |
| 330 | 207 | 330 | 209 | 330 | 209 | 330 | 208 | 330 | 209 | 330 | 209 | 330 | 210 |
| 340 | 209 | 340 | 209 | 340 | 210 | 340 | 210 | 340 | 210 | 340 | 208 | 340 | 210 |
| 350 | 209 | 350 | 209 | 350 | 210 | 350 | 209 | 350 | 208 | 350 | 209 | 350 | 209 |
| 360 | 208 | 360 | 210 | 360 | 210 | 360 | 209 | 360 | 209 | 360 | 210 | 360 | 208 |
| 370 | 210 | 370 | 208 | 370 | 210 | 370 | 209 | 370 | 208 | 370 | 208 | 370 | 209 |
| 380 | 208 | 380 | 209 | 380 | 209 | 380 | 210 | 380 | 208 | 380 | 208 | 380 | 210 |
| 385 | 210 | 385 | 209 | 385 | 209 | 385 | 208 | 385 | 208 | 385 | 210 | 385 | 208 |

TABLE 11

| Embodiment | | Comparative | | Comparative | | Comparative | | Comparative | | Comparative | |
|---|---|---|---|---|---|---|---|---|---|---|---|
| 15 | | example 6 | | example 7 | | example 8 | | example 9 | | example 10 | |
| P/ | T/ | P/ | T/ | P/ | T/ | P/ | T/ | P/ | T/ | P/ | T/ |
| mm | μm | mm | μm | mm | μm | mm | μm | mm | μm | mm | μm |
| 0 | 210 | 0 | 209 | 0 | 191 | 0 | 209 | 0 | 216 | 0 | 219 |
| 5 | 209 | 5 | 210 | 5 | 197 | 5 | 208 | 5 | 214 | 5 | 216 |
| 10 | 209 | 10 | 208 | 10 | 202 | 10 | 210 | 10 | 210 | 10 | 213 |
| 20 | 209 | 20 | 209 | 20 | 203 | 20 | 209 | 20 | 209 | 20 | 210 |
| 30 | 209 | 30 | 209 | 30 | 206 | 30 | 209 | 30 | 210 | 30 | 209 |
| 40 | 209 | 40 | 208 | 40 | 210 | 40 | 209 | 40 | 208 | 40 | 208 |
| 50 | 209 | 50 | 209 | 50 | 210 | 50 | 207 | 50 | 209 | 50 | 210 |
| 60 | 209 | 60 | 208 | 60 | 210 | 60 | 209 | 60 | 208 | 60 | 208 |
| 70 | 210 | 70 | 209 | 70 | 211 | 70 | 209 | 70 | 208 | 70 | 209 |
| 80 | 208 | 80 | 210 | 80 | 208 | 80 | 209 | 80 | 208 | 80 | 210 |
| 90 | 210 | 90 | 208 | 90 | 210 | 90 | 208 | 90 | 207 | 90 | 208 |
| 100 | 209 | 100 | 210 | 100 | 210 | 100 | 208 | 100 | 208 | 100 | 208 |
| 110 | 209 | 110 | 207 | 110 | 207 | 110 | 209 | 110 | 207 | 110 | 209 |
| 120 | 209 | 120 | 208 | 120 | 208 | 120 | 208 | 120 | 208 | 120 | 208 |
| 130 | 209 | 130 | 209 | 130 | 209 | 130 | 207 | 130 | 208 | 130 | 209 |
| 140 | 208 | 140 | 207 | 140 | 207 | 140 | 209 | 140 | 207 | 140 | 207 |
| 150 | 209 | 150 | 209 | 150 | 208 | 150 | 207 | 150 | 207 | 150 | 208 |
| 160 | 209 | 160 | 207 | 160 | 207 | 160 | 207 | 160 | 208 | 160 | 209 |
| 170 | 209 | 170 | 209 | 170 | 208 | 170 | 210 | 170 | 208 | 170 | 208 |
| 180 | 210 | 180 | 209 | 180 | 207 | 180 | 207 | 180 | 207 | 180 | 209 |
| 190 | 209 | 190 | 208 | 190 | 208 | 190 | 208 | 190 | 207 | 190 | 209 |
| 200 | 208 | 200 | 208 | 200 | 209 | 200 | 208 | 200 | 208 | 200 | 208 |
| 210 | 209 | 210 | 208 | 210 | 210 | 210 | 208 | 210 | 208 | 210 | 208 |
| 220 | 208 | 220 | 209 | 220 | 211 | 220 | 209 | 220 | 208 | 220 | 209 |
| 230 | 208 | 230 | 207 | 230 | 207 | 230 | 207 | 230 | 207 | 230 | 207 |
| 240 | 209 | 240 | 208 | 240 | 208 | 240 | 208 | 240 | 208 | 240 | 208 |
| 250 | 209 | 250 | 210 | 250 | 207 | 250 | 209 | 250 | 208 | 250 | 210 |
| 260 | 209 | 260 | 208 | 260 | 208 | 260 | 208 | 260 | 208 | 260 | 208 |
| 270 | 210 | 270 | 208 | 270 | 208 | 270 | 209 | 270 | 209 | 270 | 209 |
| 280 | 209 | 280 | 208 | 280 | 209 | 280 | 208 | 280 | 208 | 280 | 208 |
| 290 | 210 | 290 | 209 | 290 | 208 | 290 | 209 | 290 | 208 | 290 | 207 |
| 300 | 209 | 300 | 208 | 300 | 207 | 300 | 208 | 300 | 208 | 300 | 209 |
| 310 | 209 | 310 | 209 | 310 | 208 | 310 | 208 | 310 | 209 | 310 | 209 |
| 320 | 209 | 320 | 209 | 320 | 209 | 320 | 209 | 320 | 208 | 320 | 210 |
| 330 | 209 | 330 | 210 | 330 | 207 | 330 | 208 | 330 | 209 | 330 | 209 |
| 340 | 209 | 340 | 209 | 340 | 208 | 340 | 208 | 340 | 209 | 340 | 210 |
| 350 | 208 | 350 | 210 | 350 | 209 | 350 | 210 | 350 | 208 | 350 | 209 |
| 360 | 208 | 360 | 209 | 360 | 210 | 360 | 210 | 360 | 209 | 360 | 209 |
| 370 | 209 | 370 | 209 | 370 | 205 | 370 | 209 | 370 | 210 | 370 | 214 |
| 380 | 209 | 380 | 209 | 380 | 197 | 380 | 208 | 380 | 214 | 380 | 216 |
| 385 | 208 | 385 | 208 | 385 | 190 | 385 | 210 | 385 | 216 | 385 | 218 |

### Performance Test:

Testing of thickness in a transverse direction (TD) of the electrode sheet: the thickness of the electrode sheet was measured along the TD direction of the electrode sheet after the coating at intervals of 5 mm using a universal ruler, and three values were measured at each point to find the average value, and the thicknesses of all the points were summarized and plotted.

The viscosity of the negative electrode slurry was tested by a rotational viscometer, and test results are shown in Table 12.

Testing of L1, L2, H1 and H2: a universal ruler was used to measure and calculate a ratio of L1 to H1 (i.e., L1/H1), and a ratio of L2 to H1 (i.e., L2/H1), and the results are shown in Table 12, in which L1 represents a width of a thick edge area of the negative electrode coating, and H2 represents a maximum thickness of the thick edge area of the negative electrode coating, as shown in FIG. 1.

A sodium iron phosphate positive electrode, a separator and a negative electrode sheet obtained from each of the above embodiments and the comparative examples are sequentially laminated, and then assembled into a battery cell by means of winding or stacking, and the battery cell is injected with electrolyte (lithium hexafluorophosphate and a solvent, where the solvent includes: vinyl carbonate, dimethyl carbonate, and methyl ethyl carbonate with a proportion of 1:1:1) inside the battery cell. The battery cell was put into the aluminum-plastic film, welded or laser-welded with battery tabs, and then subjected to scaling and formation to obtain a soft-packed lithium-ion battery with a nominal capacity of 2.3 Ah. The discharge specific capacity of the lithium-ion battery was tested at 0.5 P. and test results were listed in Table 12.

TABLE 12

| | Viscosity | | | | | | |
|---|---|---|---|---|---|---|---|
| | of | | | | | | Discharge |
| | negative | | | | | | specific |
| Embodiment/ | electrode | | | | | | capacity |
| Comparative | slurry | H2 | | L2 | H1 | | at 0.5 P |
| example | (Pa · s) | (μm) | L1/H1 | (μm) | (μm) | L2/H1 | (mAh) |
| Embodiment | 7014 | 209 ± 1.5 | 0 | 100 ± 1 | 209 ± 1.5 | 0.48 | 2.33 |
| 8 | | | | | | | |
| Embodiment | 7327 | 209 ± 1.5 | 0 | 100 ± 1 | 209 ± 1.5 | 0.48 | 2.32 |
| 9 | | | | | | | |
| Embodiment | 7297 | 209 ± 1.5 | 0 | 100 ± 1 | 209 ± 1.5 | 0.48 | 2.31 |
| 10 | | | | | | | |
| Embodiment | 7311 | 209 ± 1.5 | 0 | 100 ± 1 | 209 ± 1.5 | 0.48 | 2.34 |
| 11 | | | | | | | |
| Embodiment | 7285 | 209 ± 1.5 | 0 | 100 ± 1 | 209 ± 1.5 | 0.48 | 2.35 |
| 12 | | | | | | | |
| Embodiment | 7410 | 209 ± 1.5 | 0 | 100 ± 1 | 209 ± 1.5 | 0.48 | 2.34 |
| 13 | | | | | | | |
| Embodiment | 7352 | 209 ± 1.5 | 0 | 100 ± 1 | 209 ± 1.5 | 0.48 | 2.31 |
| 14 | | | | | | | |
| Embodiment | 7279 | 209 ± 1.5 | 0 | 100 ± 1 | 209 ± 1.5 | 0.48 | 2.32 |
| 15 | | | | | | | |
| Comparative | 6963 | 209 ± 1.5 | 0 | 100 ± 1 | 209 ± 1.5 | 0.48 | 2.35 |
| example 6 | | | | | | | |
| Comparative | 7743 | / | / | / | 209 ± 1.5 | / | 2.34 |
| example 7 | | | | | | | |
| Comparative | 7537 | 209 ± 1.5 | 0 | 100 ± 1 | 209 ± 1.5 | 0.48 | 2.34 |
| example 8 | | | | | | | |
| Comparative | 7236 | 216 ± 1.5 | 5.72 | 100 ± 1 | 209 ± 1.5 | 0.48 | / |
| example 9 | | | | | | | |
| Comparative | 6918 | 219 ± 1.5 | 8.31 | 100 ± 1 | 209 ± 1.5 | 0.48 | / |
| example 10 | | | | | | | |

As can be seen from Table 12 in combination with FIG. 11, compared with the other embodiments in which the second solvent or surfactant is too much, in the formulation for the negative electrode slurry of embodiment 10, the addition of the appropriate amount of surfactant reduces the usage amount of the second solvent and ensures the coating performance of the negative electrode slurry, while ensuring the elimination of “thick edge” during the coating process.

As can be seen from the data in table 12, the method of embodiments 8 to 15 not only solves the problem of “thick edge” of the coating, but also ensures that the lithium-ion battery has a high discharge capacity and stability.

In comparative example 6, although the effect of eliminating the “thick edge” can be achieved, a relatively large amount of the second solvent is used and the thickener is introduced, which reduces the coating performance and energy density of the slurry. In comparative example 7, the traditional method of eliminating “thick edge” by thinning is adopted, which brings about the risk of lithium precipitation at the edge and thus greatly reduces the cycling performance and safety performance of the battery cell. In comparative examples 8 and 9, the proportion of the second solvent ratio is not in an appropriate range, resulting in a poor coating performance of the negative electrode slurry or a poor effect of elimination of “thick edge.” In comparative example 10, a second solvent that does not meet the requirements is selected, resulting in that the “thick edge” formed during the coating process cannot be eliminated. In the actual production of the negative electrode slurry in all the above comparative examples, it was not possible to achieve excellent coating performance and significant effect of eliminating “thick edge” at the same time.

In the present disclosure, a solvent blending method is adopted, that is, an organic solvent having a lower surface tension and a higher boiling point than water is introduced to be blended with water to prepare the negative electrode slurry. In the solvent blending method derived from the intrinsic mechanism of the formation of “thick edge” of the coating, the solvent having the lower surface tension and the higher boiling point than water is blended with water firstly, and then the double-solvent slurry is baked so that the second solvent has a higher concentration at the edge than at the middle in the drying process due to its higher boiling point, whereby a surface tension gradient is formed from the inside to the edge of the coating, inducing slurry particles at the edge to move toward the inside of the coating, which counteracts the effect of capillary action in the formation of “thick edge,” i.e., counteracting the edge aggregation effect brought about by the capillary action, thus solving the problem of “thick edge” of the coating. However, the introduction of the solvent with the higher boiling point requires a higher baking temperature and a longer baking time to dry the electrode sheet, which makes the electrode sheet prone to cracking under the higher baking temperature and longer baking time. In view of the above problem, the present disclosure introduces a surfactant, and due to the role of hydrophilic and hydrophobic groups in the surfactant, the surfactant may form a uniform adsorption layer on the surface layer of the graphite particles, making the graphite particles as a whole negatively charged, and electrostatic interaction and steric hindrance generated by effective adsorption of the graphite particles effectively reduces the capillary effect, reduce the “thick edge” effect (that is, reducing aggregation of graphite particles at the edge), and reduce the amount of the solvent with the higher boiling point, so that the viscosity of the slurry is improved to be in an appropriate range (thereby eliminating the use of thickener), and then the coating baking temperature is reduced, which significantly improves the cracking problem of the slurry in the coating process, while reducing the energy consumption for baking and the costs. In addition, compared with the thinning method, the method of eliminating the thick edge in the present disclosure is not only simple to operate, but also capable of improving the energy density of the battery cell, reducing the risk of lithium precipitation at the edge of the electrode sheet, and ensuring the fit of the electrode sheet in the assembly process, thereby significantly improving the stability, safety and electrical performance of the battery cell.

The above are only exemplary embodiments of the present disclosure, and are not intended to limit the present disclosure. Various changes and variations may be made to the present disclosure for those skilled in the art. Any modifications, equivalent substitutions, improvements and the like made within the principles of the present disclosure shall fall into the scope of protection of the present disclosure.

What is claimed is:

1. A method for preparing a secondary battery, wherein the secondary battery includes a battery cell, the battery cell includes a positive electrode, a negative electrode, a separator and an electrolyte, and the negative electrode includes a negative current collector, and a negative electrode material coating laminated to a surface of the negative current collector, the method comprising:
preparing a negative electrode slurry, coating the negative electrode slurry on the negative current collector, and then drying and compacting the negative electrode slurry to form the negative electrode material coating, thereby obtaining the negative electrode;
preparing a positive electrode slurry, coating the positive electrode slurry on a positive electrode collector, and then drying and compacting the positive electrode slurry, thereby obtaining the positive electrode; and
assembling the positive electrode, the negative electrode, the separator and the electrolyte to obtain the secondary battery;
wherein preparing the negative electrode slurry includes:
blending a negative electrode active material, a conductive agent, a binder, a dispersant, a solvent, and a thickener to obtain the negative electrode slurry;
wherein an amount of the negative electrode active material is 96 to 98 parts by weight, an amount of the conductive agent is 0.6 to 1.2 parts by weight, an amount of the binder is 1 to 2.5 parts by weight, an amount of the dispersant is 0.5 to 1.5 parts by weight, an amount of the solvent is 80 to 100 parts by weight, and an amount of the thickener is 1.5 to 3 parts by weight; and
wherein the solvent includes a first solvent and a second solvent, the first solvent is water, the second solvent is an organic solvent, the second solvent has a boiling point of 110° C. to 210° C. and a surface tension of 20 dyn/cm to 50 dyn/cm, and a mass ratio of the second solvent to the first solvent is 1:10 to 1:2.

2. The method according to claim 1, wherein the boiling point of the second solvent is 10° C. to 110° C. higher than a boiling point of the water, the surface tension of the second solvent is 15 dyn/cm to 50 dyn/cm lower than a surface tension of the water, and the water is deionized water.

3. The method according to claim 1, wherein an amount of the second solvent is 15 to 30 parts by weight.

4. The method according to claim 1, wherein the second solvent is selected from any one or more of ethylene glycol, ethylenediamine, butanol, acetic acid, propylene glycol and methyl formamide.

5. The method according to claim 1, wherein the negative electrode slurry has a viscosity of 6000 Pa·s to 9000 Pa·s.

6. The method according to claim 1, wherein the negative electrode active material is selected from any one or more of graphite, a silicon material, a silicon carbon material, and hard carbon.

7. The method according to claim 1, wherein the conductive agent is selected from any one or more of a SP (Super-P) conductive agent, carbon black, carbon nanotubes, graphene.

8. The method according to claim 1, wherein the binder is at least one of an SBR (styrene butadiene rubber) binder and a PAA (polyacrylic acid) binder.

9. The method according to claim 1, wherein the dispersant is a CMC (carboxymethyl cellulose) dispersant.

10. The method according to claim 1, wherein in a width direction of the negative electrode material coating, the negative electrode material coating includes an intermediate zone and an edge transition zone disposed on each of both sides of the intermediate zone, a thickness of the edge transition zone gradually decreases in a direction away from the intermediate zone, the intermediate zone has a thickness of H1, and the edge transition zone has a width of L2 in the direction away from the intermediate zone, wherein L2/H1 is 0.004 to 0.01:1.

11. The method according to claim 10, wherein L2 is 1 mm to 2 mm, and H1 is 200 mm to 230 mm.

12. The method according to claim 1, wherein blending the negative electrode active material, the conductive agent, the binder, the dispersant, the solvent, and the thickener to obtain the negative electrode slurry includes:
dry blending the negative electrode active material, the conductive agent and the dispersant to obtain a dry blend;
kneading the dry blend with a part of the first solvent to obtain a kneaded material;
subjecting the kneaded material, the remaining part of the first solvent, the second solvent to a first wet blending to obtain a first wet blend; and
subjecting the first wet blend, the thickener and the binder to a second wet blending to obtain the negative electrode slurry.

13. The method according to claim 1, wherein a mass ratio of the thickener to the second solvent is 1:20 to 1:5.

14. The method according to claim 1, wherein the thickener is selected from any one or more of polyethylene glycol, polyacrylate, and hydroxyethyl cellulose.

15. The method according to claim 14, wherein the polyethylene glycol has a molecular weight of less than 600.

16. The method according to claim 1, wherein the negative electrode slurry includes 96 to 97 parts by weight of graphite, 0.8 to 1.0 parts by weight of a SP conductive agent, 2 to 2.5 parts by weight of a SBR binder, 1.2 to 1.5 parts by weight of a CMC dispersant, 15 to 30 parts by weight of ethylene glycol, 60 to 75 parts by weight of deionized water, and 2 to 3 parts by weight of polyethylene glycol.

17. The method according to claim 1, wherein parameters during the dry blending include:
a rotational speed of 15 rpm to 25 rpm, a stirring speed of 500 rpm to 800 rpm, and a stirring time of 30 min to 60 min.

18. The method according to claim 17, wherein parameters during the kneading include:
a kneading time of 60 min to 80 min, a rotational speed of 20 rpm to 25 rpm, and a stirring speed of 300 rpm to 500 rpm.

19. The method according to claim 17, wherein parameters during the first wet blending include: a rotational speed of 22 rpm to 25 rpm, a stirring speed of 1000 rpm to 1500 rpm, and a stirring time of 90 min to 120 min.

20. The method according to claim 1, wherein parameters during the second wet blending include: a rotational speed of 22 rpm to 25 rpm, a stirring speed of 300 rpm to 600 rpm, and a stirring time of 30 min to 40 min.
